(19) United States
(12) Patent Application Publication
(10) Pub. No.: US 2013/0235093 A1
(43) Pub. Date: Sep. 12, 2013

(54) METHOD FOR DRIVING DISPLAY DEVICE, DISPLAY DEVICE, AND ELECTRONIC DEVICE

(71) Applicant: SEMICONDUCTOR ENERGY LABORATORY CO., LTD., (US)

(72) Inventor: Hiroyuki MIYAKE, Atsugi (JP)

(73) Assignee: SEMICONDUCTOR ENERGY LABORATORY CO., LTD., Atsugi-shi (JP)

(21) Appl. No.: 13/775,684

(22) Filed: Feb. 25, 2013

(30) Foreign Application Priority Data
Mar. 9, 2012 (JP) 2012-052723

(51) Int. Cl. G09G 5/02

(52) U.S. Cl. CPC G09G 5/02; G09G 3/3607
USPC 345/691; 345/88

(57) ABSTRACT

Degradation in image quality of a display image is prevented. A pixel portion which includes a plurality of pixel circuits in row and column directions is divided into a plurality of regions in the row direction. In each of the plurality of regions, operation in which data is written to the pixel circuits on a row basis and the pixel circuits to which the data is written are irradiated with light corresponding to the written data is performed a plurality of times in one frame period in such a manner that at least three single-color image data for displaying the three primary colors are written in one frame period; and black image data is written to the pixel circuits every time before any of the plurality of single-color image data is written to the pixel circuits in each of the plurality of regions.

### BACKGROUND OF THE INVENTION

1. Field of the Invention

One embodiment of the present invention relates to a display device. Further, one embodiment of the present invention relates to an electronic device including a panel which uses the display device.

2. Description of the Related Art

In recent years, a display device using a method in which the color of light transmitted to a pixel circuit is changed a plurality of times in one frame period so that a full-color image can be displayed (such a method is referred to as a field-sequential method) has been developed (for example, see Patent Document 1). When a field-sequential method is employed, for example, a color filter is not needed in a liquid crystal display device, and thus, light transmittance can be increased.

In a display device using a field-sequential method in Patent Document 1, a pixel portion including pixel circuits in the row and column directions is divided into a plurality of regions in the row direction, data is written to each of the pixel circuits in each of the plurality of regions, and the pixel circuit to which data is written is irradiated with light corresponding to the written data. This operation is performed a plurality of times in one frame period in such a manner that red image data, green image data, and blue image data are written. In this manner, images are displayed.

### REFERENCE

### Patent Document

[Patent Document 1] Japanese Published Patent Application No. 2006-220685

### SUMMARY OF THE INVENTION

A display device using a conventional field-sequential method has a problem of low quality of a display image.

For example, in the display device described in Patent Document 1, in the case where the pixel circuit to which image data for a specific color has been written is irradiated with light of a corresponding color, the light is diffused in some cases so that the pixel circuit to which image data for another color has been written is also irradiated with the light. Consequently, the color reproducibility of a display image is degraded so that a display defect occurs. Accordingly, the quality of the display image is degraded.

An object of one embodiment of the present invention is to prevent degradation in image quality of a display image.

In one embodiment of the present invention, a pixel portion is divided into a plurality of regions in the row direction. In each of the plurality of regions, operation in which data is written to pixel circuits on a row basis and the pixel circuits are irradiated with light corresponding to the written data is performed a plurality of times in one frame period in such a manner that at least a plurality of single-color image data for displaying the three primary colors are written. In other words, at least three single-color image data for displaying the three primary colors are written in one frame period.

Further, in one embodiment of the present invention, in each of the plurality of regions, black image data is written to the pixel circuits every time before any of the plurality of single-color image data is written to the pixel circuits.

Accordingly, even in the case where the pixel circuit which is not a target pixel circuit is irradiated with light of a specific color owing to light diffusion, a display image can be black.

In one embodiment of the present invention, the above operation is performed by providing a first transistor and a second transistor in the pixel circuit.

The first transistor has a function of controlling whether to write single-color image data for displaying the three primary colors, and the second transistor has a function of controlling whether to write black image data.

By providing the first transistor and the second transistor, writing of single-color image data for displaying the three primary colors and writing of black image data can be controlled independently of each other, and the interval between the timing at which single-color image data for displaying the three primary colors is written and the timing at which black image data is written can be made short; thus, high-speed operation is possible.

One embodiment of the present invention is a method for driving a display device including a pixel portion which includes a plurality of pixel circuits in row and column directions and which is divided into a plurality of regions in the row direction. The method includes the steps of: in each of the plurality of regions, performing operation in which data is written to the pixel circuits on a row basis and the pixel circuits to which the data is written are irradiated with light corresponding to the written data a plurality of times in one frame period in such a manner that at least a plurality of single-color image data for displaying the three primary colors are written; and writing black image data to the pixel circuits every time before any of the plurality of single-color image data is written to the pixel circuits in each of the plurality of regions.

Another embodiment of the present invention is a display device including: a pixel portion including a plurality of pixel circuits in row and column directions; and a driver circuit portion which controls driving of the pixel circuits. Each of the plurality of pixel circuits includes: a liquid crystal element whose alignment state depends on written data; a first transistor having a function of controlling whether to write, as the data, single-color image data for displaying the three primary colors by being turned on or off; and a second transistor having a function of controlling whether to write, as the data, black image data by being turned on or off. The driver circuit portion includes: a first driver circuit which controls a potential of a gate of the first transistor in each of the plurality of pixel circuits in each of a plurality of regions into which the pixel portion is divided in the row direction; and a second driver circuit which controls a potential of a gate of the second transistor in each of the plurality of pixel circuits such that, before the first transistor is turned on, the second transistor is turned on and then turned off.

According to one embodiment of the present invention, degradation in image quality of a display image can be prevented.

For example, according to one embodiment of the present invention, a pixel circuit to which image data corresponding to a specific color has been written can be prevented from being irradiated with light of another color. Consequently, the color reproducibility of a display image is improved, and the quality of the display image is improved.

### BRIEF DESCRIPTION OF THE DRAWINGS

FIGS. 1A and 1B illustrate an example of a display device.

FIGS. 2A and 2B illustrate a structural example of a pixel portion and a driver circuit portion.

FIGS. 3A and 3B illustrate a structural example of the pixel portion and the driver circuit portion.

FIG. 4 illustrates a structural example of the pixel portion and the driver circuit portion.

FIG. 5 illustrates a structural example of the driver circuit.

FIG. 6 illustrates a structural example of a flip-flop.

FIG. 7 is a timing chart illustrating a method for driving the flip-flop.

FIG. 8 is a timing chart illustrating a method for driving the driver circuit.

FIGS. 9A to 9C illustrate a structural example of a light source portion.

FIG. 10 is a timing chart illustrating an example of a method for driving the display device.

FIG. 11 is a timing chart illustrating an example of a method for driving the display device.

FIG. 12 is a timing chart illustrating an example of a method for driving the display device.

FIG. 13 is a schematic cross-sectional view of a structural example of the display device.

FIGS. 14A to 14D illustrate examples of an electronic device.

### DETAILED DESCRIPTION OF THE INVENTION

Examples of an embodiment according to the present invention will be described. Note that it will be readily appreciated by those skilled in the art that details of the embodiments can be modified in various ways without departing from the spirit and scope of the present invention. Thus, the present invention should not be limited to, for example, the description of the following embodiments.

Note that the contents in different embodiments can be combined with one another as appropriate. In addition, the contents in different embodiments can be replaced with one another as appropriate.

Further, the ordinal numbers such as “first” and “second” are used to avoid confusion between components and do not limit the number of each component.

### Embodiment 1

In this embodiment, examples of a field-sequential display device will be described.

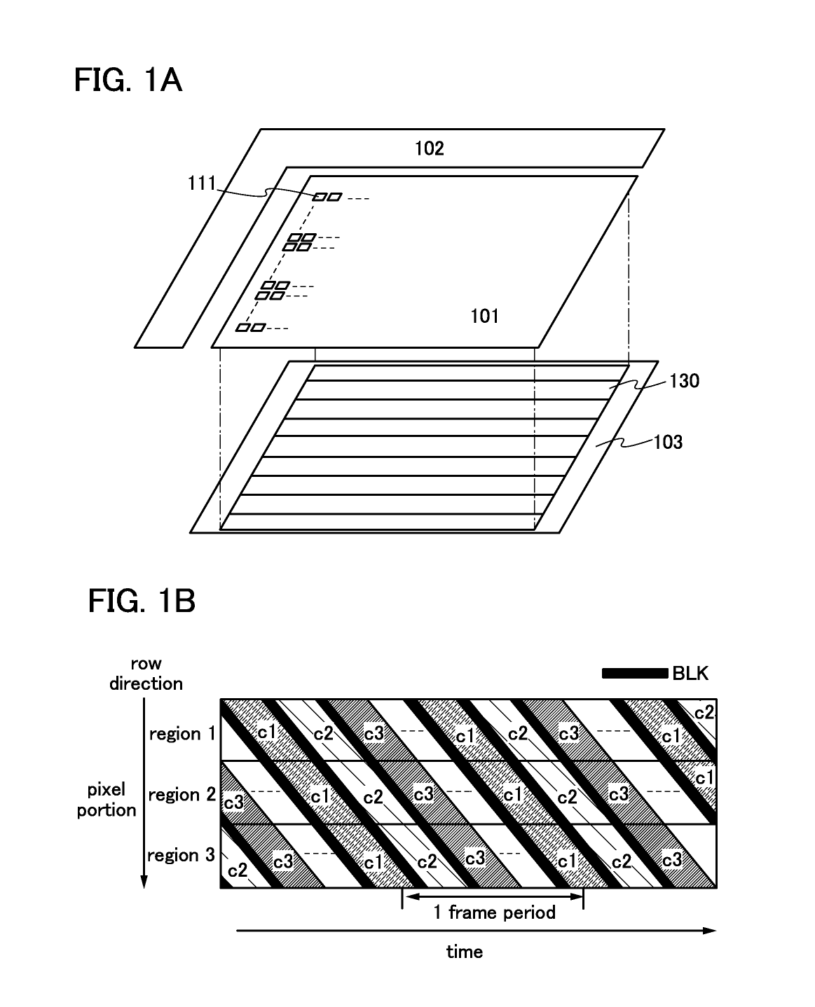

FIG. 1A is a block diagram illustrating a structural example of a display device of this embodiment.

The display device in FIG. 1A includes a pixel portion 101, a driver circuit portion 102, and a light source portion 103. Note that the driver circuit portion 102 and the light source portion 103 are not necessarily provided inside the display device.

The pixel portion 101 includes a plurality of pixel circuits 111 arranged in the row and column directions.

Data is written to the pixel circuits 111, and the pixel circuits 111 change their display states according to the written data.

The pixel portion 101 is divided into a plurality of regions in the row direction. The driver circuit portion 102 has a function of controlling writing of data to the pixel circuits 111 in each of the plurality of regions.

In the light source portion 103, each of the plurality of regions is further divided into a plurality of light-emitting regions 130 in the row direction. Each of the plurality of light-emitting regions 130 has a function of irradiating the pixel circuit 111 with light corresponding to data written to the pixel circuit 111.

In the light source portion 103, for example, a light-emitting diode emitting red light, a light-emitting diode emitting green light, and a light-emitting diode emitting blue light are provided. Light emission from the plurality of kinds of light-emitting diodes is controlled in response to data written to the pixel circuits 111, whereby the pixel circuits 111 can display images whose colors correspond to the written data.

Next, an example of a method for driving the display device in FIG. 1A will be described with reference to FIG. 1B. FIG. 1B schematically shows a temporal change in color of images displayed on the pixel portion 101.

In this example of the method for driving the display device in FIG. 1A, the pixel portion 101 is divided into a plurality of regions (regions 1 to 3) in the row direction, and the pixel circuits 111 are driven on a region basis.

At this time, in each of the regions 1 to 3, data is written to the pixel circuits 111 on a row basis, and the pixel circuits 111 are irradiated with light corresponding to the written data (this operation is referred to as display operation). With the display operation, each of the regions 1 to 3 displays an image corresponding to data written to the pixel circuits 111.

Light corresponding to data written to the pixel circuit 111 is emitted from any of the plurality of light-emitting regions 130 in the light source portion 103, for example.

The display operation is performed a plurality of times in one frame period in such a manner that at least a plurality of single-color image data for displaying the three primary colors are written.

As the plurality of single-color image data for displaying the three primary colors, red (R) image data, green (G) image data, and blue (B) image data can be used. Note that the plurality of single-color image data for displaying the three primary colors are not limited thereto, and may be, for example, cyan (C) image data, magenta (M) image data, and yellow (Y) image data.

For example, as illustrated in FIG. 1B, in each of the regions 1 to 3, single-color image data for a first color c1, a second color c2, and a third color c3 forming the three primary colors are sequentially written to the pixel circuits 111 in one frame period, and the pixel circuits 111 are irradiated with lights corresponding to the written data; thus, single-color images of the first color c1, the second color c2, and the third color c3 are sequentially displayed. Note that as illustrated in FIG. 1B, in each display operation, the color of single-color image data written to the pixel circuits 111 may vary among the regions 1 to 3.

Further, in this example of the method for driving the display device in FIG. 1A, in each of the regions 1 to 3, black (BLK) image data is written to the pixel circuits 111 so that a black image is displayed every time before any of the plurality of single-color image data is written to the pixel circuits 111.

For example, as illustrated in FIG. 1B, in each of the regions 1 to 3, every time before any of single-color image data for the first color c1, the second color c2, and the third color c3 is written to the pixel circuits 111 and a single-color image corresponding to the written data is displayed, black (BLK) image data is written to the pixel circuits 111 and a black image is displayed. At this time, the light-emitting regions 130 in the light source portion 103 having a function of emitting light to the pixel circuits 111 to which the black image is written may be turned off. Accordingly, power consumption can be reduced.

At this time, the period during which the black image data is retained is preferably shorter than the period during which the single-color image data is retained. With this, a reduction in operation speed and a reduction in luminance can be prevented. Note that the period during which the black image is retained is not necessarily provided.

The black image data is written as described above, whereby, even in the case where the pixel circuit which is not a target pixel circuit is irradiated with light of a specific color owing to light diffusion, the pixel circuit displays the black image. Accordingly, a display defect hardly occurs.

The above is a description of the example of the method for driving the display device in FIG. 1A.

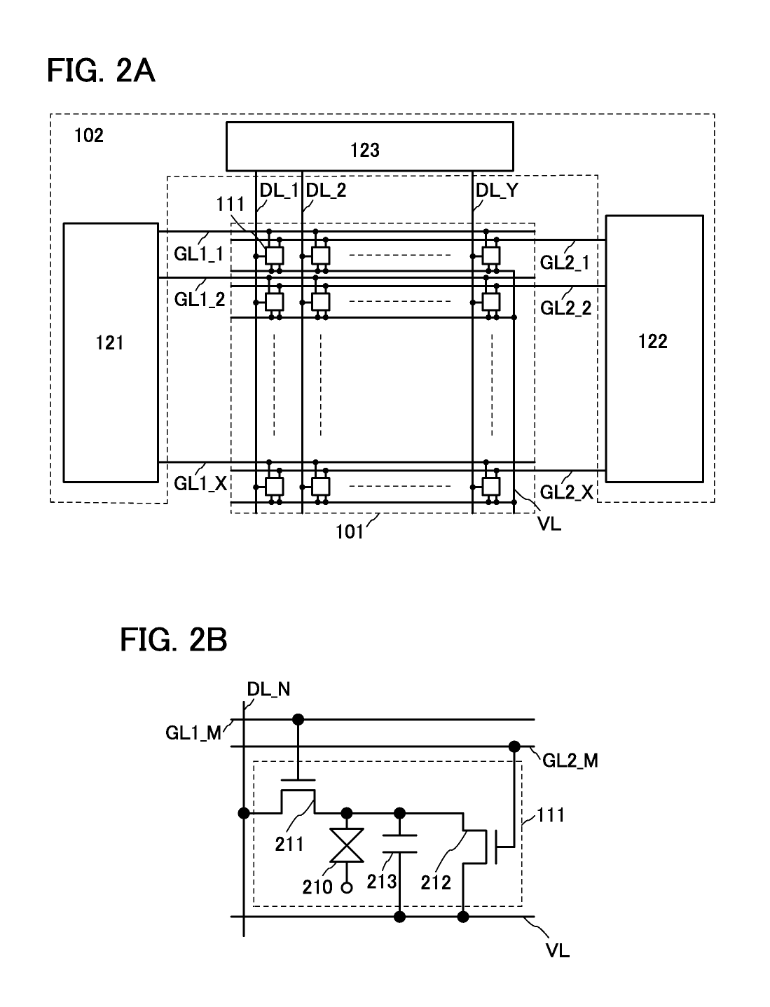

Next, a structural example of the pixel portion 101 and the driver circuit portion 102 will be described with reference to FIGS. 2A and 2B.

FIG. 2A illustrates the structural example of the pixel portion 101 and the driver circuit portion 102.

As illustrated in FIG. 2A, the pixel portion 101 includes the plurality of pixel circuits 111 arranged in X rows and Y columns (X and Y are each a natural number of 2 or more), and the driver circuit portion 102 includes a driver circuit 121, a driver circuit 122, and a driver circuit 123. Note that the driver circuit 123 is not necessarily provided inside the display device.

To each of the plurality of pixel circuits 111, a pulse signal PS1 is input through one of a plurality of scan lines GL1_1 to GL1_X, a pulse signal PS2 is input through one of a plurality of scan lines GL2_1 to GL2_X, and a data signal DS is input through one of a plurality of data lines DL_1 to DL_Y. For example, to the pixel circuit 111 in the M-th row and the N-th column, a pulse signal PS1_M (M is a natural number of X or less) is input from the driver circuit 121 through the scan line GL1_M, a pulse signal PS2_M is input from the driver circuit 122 through the scan line GL2_M, and a data signal DS_N (N is a natural number of Y or less) is input from the driver circuit 123 through the data line DL_N.

As illustrated in FIG. 2B, each of the plurality of pixel circuits 111 includes a liquid crystal element 210, a transistor 211, a transistor 212, and a capacitor 213.

The potential of one of a pair of electrodes of the liquid crystal element 210 is set according to the specifications of the pixel circuit 111 as appropriate. The alignment state of the liquid crystal element 210 depends on written data.

In the pixel circuit 111 in the M-th row and the N-th column, one of a source and a drain of the transistor 211 is electrically connected to the data line DL_N, and the other is electrically connected to the other of the pair of electrodes of the liquid crystal element 210. A gate of the transistor 211 is electrically connected to the scan line GL1_M.

The transistor 211 has a function of controlling whether to write single-color image data for displaying the three primary colors by being turned on or off.

In the pixel circuit 111 in the M-th row and the N-th column, one of a source and a drain of the transistor 212 is electrically connected to a potential supply line VL, and the other is electrically connected to the other of the pair of electrodes of the liquid crystal element 210. A gate of the transistor 212 is electrically connected to the scan line GL2_M. The potential of the potential supply line VL is set according to the specifications of the pixel circuit 111 as appropriate.

The transistor 212 has a function of controlling whether to write black image data by being turned on or off.

One of a pair of electrodes of the capacitor 213 is electrically connected to the potential supply line VL, and the other is electrically connected to the other of the pair of electrodes of the liquid crystal element 210.

The capacitor 213 functions as a storage capacitor for retaining written data. Note that the capacitor 213 is not necessarily provided.

The driver circuit 121 has a function of controlling the on/off state of the transistor 211.

For example, the pixel portion 101 is divided into a plurality of regions, and the driver circuit 121 controls the potentials of the gates of the transistors 211 in the plurality of pixel circuits 111 in each of the plurality of regions. The potentials of the gates of the transistors 211 in the plurality of pixel circuits 111 depend on the potentials of the scan lines GL1_1 to GL1_X, for example. A start pulse signal is input to the driver circuit 121a plurality of times corresponding to the number of single-color image data for displaying the three primary colors written to the pixel circuits in one frame period. The driver circuit 121 sequentially outputs the plurality of pulse signals PS1 to the corresponding scan lines GL1_1 to GL1_X in response to the start pulse signals, whereby the potentials of the scan lines GL1_1 to GL1_X are controlled.

The driver circuit 122 has a function of controlling the on/off state of the transistor 212.

For example, the driver circuit 122 controls the potential of the gate of the transistor 212 in each of the plurality of pixel circuits 111 such that, before the transistor 211 is turned on, the transistor 212 is turned on and then turned off. The potentials of the gates of the transistors 212 in the plurality of pixel circuits 111 depend on the potentials of the scan lines GL2_1 to GL2_X, for example. A start pulse signal is input to the driver circuit 122 a plurality of times corresponding to the number of black image data written to the pixel circuits in one frame period. The driver circuit 122 sequentially outputs the plurality of pulse signals PS2 to the corresponding scan lines GL2_1 to GL2_X in response to the start pulse signals, whereby the potentials of the scan lines GL2_1 to GL2_X are controlled.

The driver circuit 121 and the driver circuit 122 each include, for example, a plurality of flip-flops.

Image signals are input to the driver circuit 123. The driver circuit 123 has a function of generating data signals written to the pixel circuits 111 based on the image signals. For example, the driver circuit 123 has a function of controlling the potentials of the data lines DL_1 to DL_Y.

The driver circuit 123 includes, for example, a plurality of switches or the like. The image signals are time-divided, and the driver circuit 123 can output the time-divided signals using the plurality of switches. Alternatively, the driver circuit 123 may include a decoder or the like.

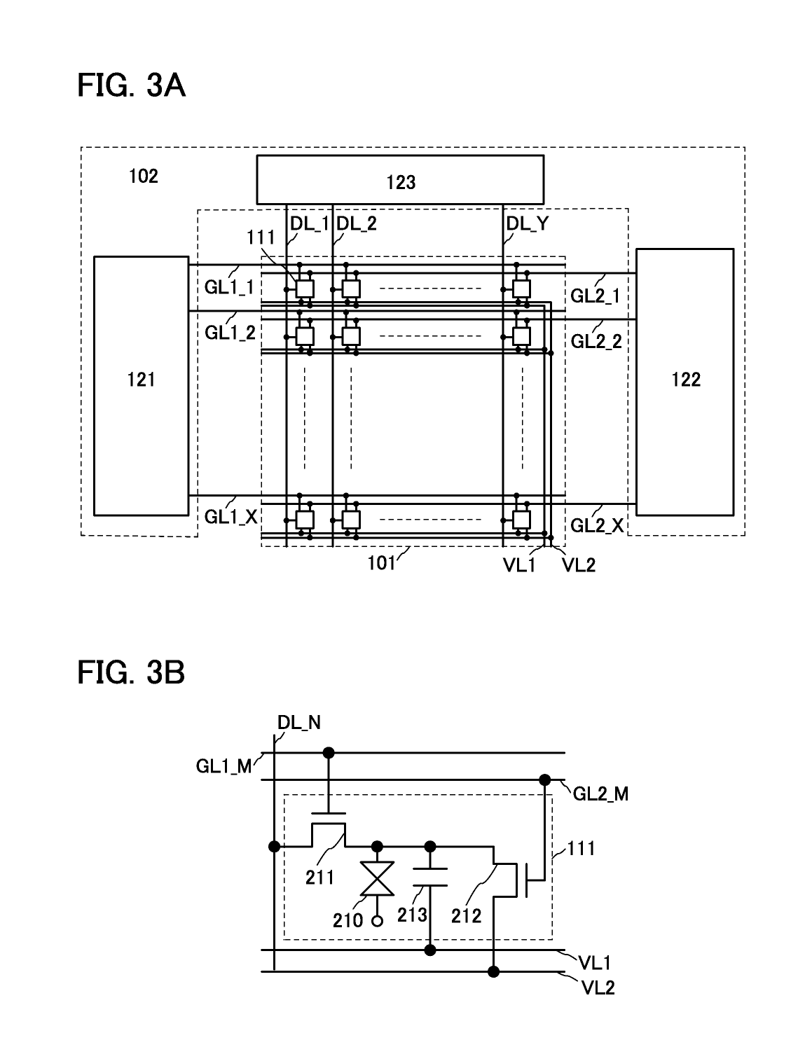

The structure of the pixel portion 101 and the driver circuit portion 102 is not limited to that illustrated in FIGS. 2A and 2B. Another structural example of the pixel portion 101 and the driver circuit portion 102 will be described with reference to FIGS. 3A and 3B.

FIG. 3A illustrates another structural example of the pixel portion 101 and the driver circuit portion 102.

The pixel portion 101 and the driver circuit portion 102 in FIG. 3A are different from the pixel portion 101 and the driver circuit portion 102 in FIG. 2A in that potential supply lines VL1 and VL2 are electrically connected to the pixel circuits 111 instead of the potential supply line VL. Here, only different points between the pixel portion 101 and the driver circuit portion 102 in FIG. 3A and those in FIG. 2A will be described below.

A structural example of the pixel circuit 111 in FIG. 3A is illustrated in FIG. 3B. As illustrated in FIG. 3B, in the pixel circuit 111, one of a source and a drain of the transistor 212 is electrically connected to the potential supply line VL2.

One of a pair of electrodes of the capacitor 213 is electrically connected to the potential supply line VL 1.

The potentials of the potential supply lines VL1 and VL2 are set according to the specifications of the pixel circuit 111 as appropriate.

For example, the liquid crystal element 210 can be normally white by setting the potential of the potential supply line VL2 as appropriate.

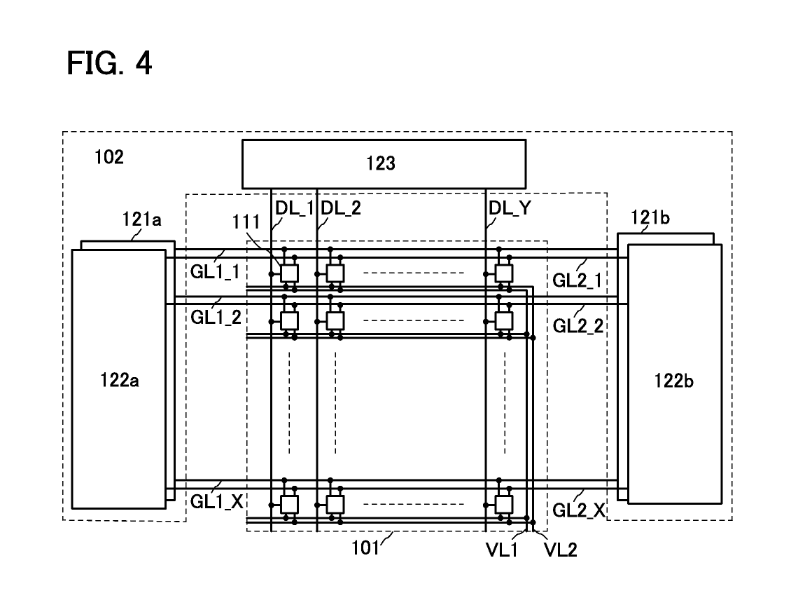

Another structural example of the driver circuit portion 102 will be described with reference to FIG. 4.

The driver circuit portion 102 in FIG. 4 includes driver circuits 121a and 121b and driver circuits 122a and 122b.

The driver circuits 121a and 121b each have a function similar to that of the driver circuit 121. It is preferable that the driver circuits 121a and 121b be provided on respective both sides of the pixel portion 101.

The driver circuits 122a and 122b each have a function similar to that of the driver circuit 122. It is preferable that the driver circuits 122a and 122b be provided on the respective both sides of the pixel portion 101.

By providing the driver circuits 121a and 121b, a delay of the pulse signals PS1 can be prevented.

By providing the driver circuits 122a and 122b, a delay of the pulse signals PS2 can be prevented.

Next, an example of a driver circuit that can be used as the driver circuit 121 or the driver circuit 122 in FIG. 2A will be described.

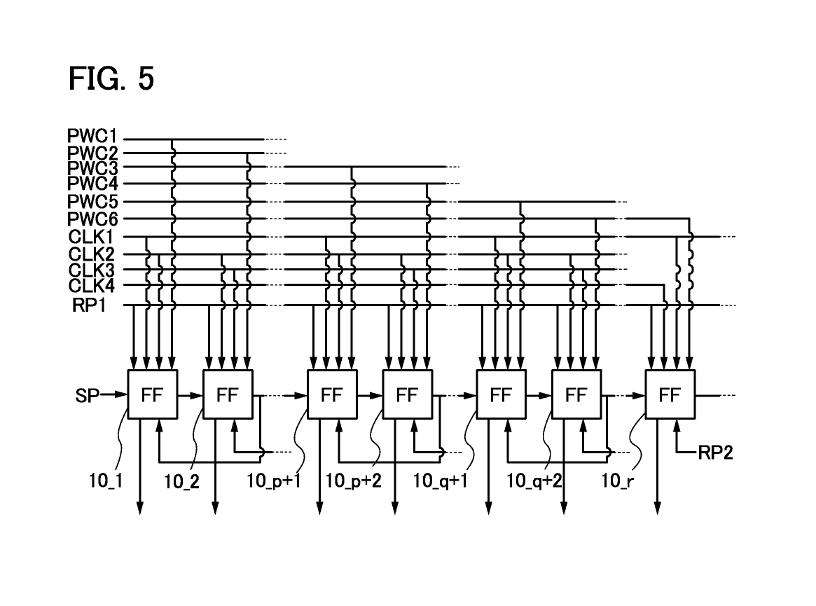

FIG. 5 illustrates a structural example of the driver circuit.

The driver circuit in FIG. 5 includes flip-flops (also referred to as FFs) 10_1 to 10_{—}r (r is a natural number of 12 or more).

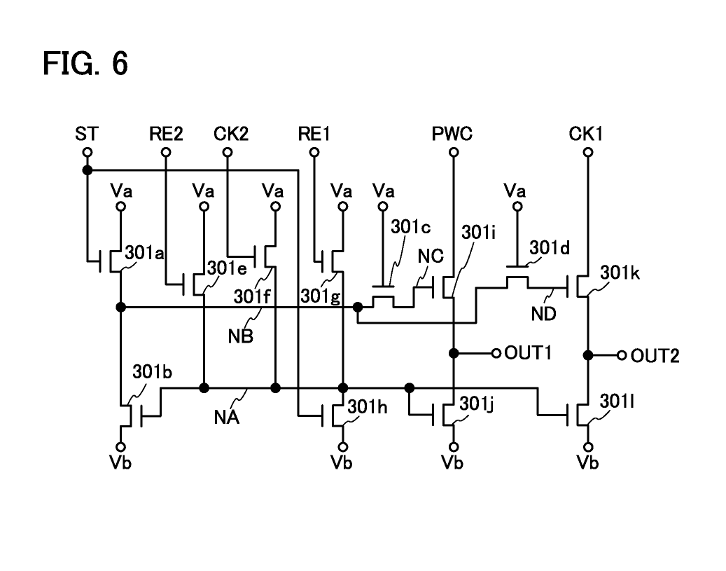

An example of a circuit structure of the flip-flop will be described with reference to FIG. 6. FIG. 6 is a circuit diagram illustrating the example of the circuit structure of the flip-flop.

To the flip-flop in FIG. 6, a set signal ST, a reset signal RE1, a reset signal RE2, a clock signal CK1, a clock signal CK2, and a pulse width control signal PWC are input. Further, from the flip-flop in FIG. 6, pulse signals OUT1 and OUT2 are output.

The reset signals RE1 and RE2 are signals for bringing the flip-flop into a reset state.

Further, the flip-flop in FIG. 6 includes transistors 301a to 301l.

One of a source and a drain of the transistor 301a is supplied with a potential Va. The set signal ST is input to a gate of the transistor 301a.

One of a source and a drain of the transistor 301b is supplied with a potential Vb, and the other is connected to the other of the source and the drain of the transistor 301a.

One of a source and a drain of the transistor 301c is connected to the other of the source and the drain of the transistor 301a. A gate of the transistor 301c is supplied with the potential Va.

One of a source and a drain of the transistor 301d is connected to the other of the source and the drain of the transistor 301a. A gate of the transistor 301d is supplied with the potential Va.

One of a source and a drain of the transistor 301e is supplied with the potential Va, and the other is connected to a gate of the transistor 301b. The reset signal RE2 is input to a gate of the transistor 301e.

One of a source and a drain of the transistor 301f is supplied with the potential Va, and the other is connected to the gate of the transistor 301b. The clock signal CK2 is input to a gate of the transistor 301f.

One of a source and a drain of the transistor 301g is supplied with the potential Va, and the other is connected to the gate of the transistor 301b. The reset signal RE1 is input to a gate of the transistor 301g.

One of a source and a drain of the transistor 301h is supplied with the potential Vb, and the other is connected to the other of the source and the drain of the transistor 301g. The set signal ST is input to a gate of the transistor 301h.

The pulse width control signal PWC is input to one of a source and a drain of the transistor 301i. A gate of the transistor 301i is connected to the other of the source and the drain of the transistor 301c.

One of a source and a drain of the transistor 301j is supplied with the potential Vb, and the other is connected to the other of the source and the drain of the transistor 301i. A gate of the transistor 301j is connected to the gate of the transistor 301b.

The clock signal CK1 is input to one of a source and a drain of the transistor 301k. A gate of the transistor 301k is connected to the other of the source and the drain of the transistor 301d.

One of a source and a drain of the transistor 301l is supplied with the potential Vb, and the other is connected to the other of the source and the drain of the transistor 301k. A gate of the transistor 301l is connected to the gate of the transistor 301b.

Note that one of the potentials Va and Vb is a high power supply potential Vdd, and the other is a low power supply potential Vss. The high power supply potential Vdd is higher than a ground potential, and the low power supply potential Vss is lower than or equal to the ground potential. The values of the potentials Va and Vb might interchange depending on the conductivity type of the transistor, for example. Note that the difference between the potential Va and the potential Vb is a power supply voltage.

In FIG. 6, a portion where the gate of the transistor 301b, the other of the source and the drain of the transistor 301e, the other of the source and the drain of the transistor 301f, the other of the source and the drain of the transistor 301h, the gate of the transistor 301j, and the gate of the transistor 301l are connected to each other is referred to a node NA.

In addition, a portion where the other of the source and the drain of the transistor 301a, the other of the source and the drain of the transistor 301b, the one of the source and the drain of the transistor 301c, and the one of the source and the drain of the transistor 301d are connected to each other is referred to as a node NB.

A portion where the other of the source and the drain of the transistor 301c and the gate of the transistor 301i are connected to each other is referred to as a node NC.

A portion where the other of the source and the drain of the transistor 301d and the gate of the transistor 301k are connected to each other is referred to as a node ND.

Note that the transistor 301c is not necessarily provided; however, with the transistor 301c, the potential of the node NB can be prevented from increasing to a potential higher than the high power supply potential Vdd in the case where the potential Va is the high power supply potential Vdd.

Further, the transistor 301d is not necessarily provided; however, with the transistor 301d, the potential of the node NB can be prevented from increasing to a potential higher than the high power supply potential Vdd in the case where the potential Va is the high power supply potential Vdd.

The above is a description of the circuit structure of the flip-flop.

Next, the driver circuit illustrated in FIG. 5 will be described below.

In the driver circuit illustrated in FIG. 5, a start pulse signal is input as the set signal ST to the flip-flop 10_1.

To the flip-flop 10_K (K is a natural number greater than or equal to 2 and less than or equal to r), the pulse signal OUT2 output from the flip-flop 10_K−1 is input as the set signal ST.

To the flip-flop 10_H (H is a natural number of r−1 or less), the pulse signal OUT2 output from the flip-flop 10_H+1 is input as the reset signal RE1.

A reset pulse signal RP2 is input as the reset signal RE1 to the flip-flop 10_{—}r.

A reset pulse signal RP1 is input as the reset signal RE2 to the flip-flops 10_1 to 10_{—}r.

The flip-flops 10_1 to 10_{—}r are divided into three groups: a group of the flip-flops 10_1 to 10_{—}p, a group of the flip-flops 10_{—}p+1 to 10_{—}q, and a group of 10_{—}q+1 to 10_{—}r. A clock signal CLK1 is input as the clock signal CK1 to every four flip-flops from the flip-flop 10_1, the flip-flop 10_{—}p+1, and the flip-flop 10_{—}q+1 in the respective groups. Further, a clock signal CLK2 is input as the clock signal CK2 to every four flip-flops from the flip-flop 10_1, the flip-flop 10_{—}p+1, and the flip-flop 10_{—}q+1 in the respective groups.

The clock signal CLK2 is input as the clock signal CK1 to every four flip-flops from the flip-flop 10_2, the flip-flop 10_{—}p+2, and the flip-flop 10_{—}q+2 in the respective groups. Further, a clock signal CLK3 is input as the clock signal CK2 to every four flip-flops from the flip-flop 10_2, the flip-flop 10_{—}p+2, and the flip-flop 10_{—}q+2 in the respective groups.

The clock signal CLK3 is input as the clock signal CK1 to every four flip-flops from the flip-flop 10_3, the flip-flop 10_{—}p+3, and the flip-flop 10_{—}q+3 in the respective groups. Further, a clock signal CLK4 is input as the clock signal CK2 to every four flip-flops from the flip-flop 10_3, the flip-flop 10_{—}p+3, and the flip-flop 10_{—}q+3 in the respective groups.

The clock signal CLK4 is input as the clock signal CK1 to every four flip-flops from the flip-flop 10_4, the flip-flop 10_{—}p+4, and the flip-flop 10_{—}q+4 in the respective groups. Further, the clock signal CLK1 is input as the clock signal CK2 to every four flip-flops from the flip-flop 10_4, the flip-flop 10_{—}p+4, and the flip-flop 10_{—}q+4 in the respective groups.

The duty ratio of each of the clock signals CLK1 to CLK4 is 25%, and the clock signals CLK1 to CLK4 are sequentially delayed by a quarter of one cycle period.

A pulse width control signal PWC1 is input to the flip-flops in odd-numbered stages among the flip-flops 10_1 to 10_{—}p (p is a natural number greater than or equal to 4 and less than r−8), and a pulse width control signal PWC2 is input to the flip-flops in even-numbered stages among them. A pulse width control signal PWC3 is input to the flip-flops in odd-numbered stages among the flip-flops 10_{—}p+1 to 10_{—}q (q is a natural number greater than or equal to p+4 and less than or equal to r−4), and a pulse width control signal PWC4 is input to the flip-flops in even-numbered stages among them. A pulse width control signal PWC5 is input to the flip-flops in odd-numbered stages among the flip-flops 10_{—}q+1 to 10_{—}r, and a pulse width control signal PWC6 is input to the flip-flops in even-numbered stages among them.

Each of the pulse width control signals PWC1 to PWC6 is a pulse signal and has a duty ratio of 33%. The pulse width control signals PWC1 to PWC6 are sequentially delayed by a sixth of one cycle period.

The pulse signal OUT1 output from each of the flip-flops 10_1 to 10_{—}r is a signal that controls scan lines. For example, in the case where the driver circuit in FIG. 5 is used as the driver circuit 121, the pulse signal OUT1 corresponds to the pulse signal PS1 that controls the scan lines GL1_1 to GL1_X; in the case where the driver circuit in FIG. 5 is used as the driver circuit 122, the pulse signal OUT1 corresponds to the pulse signal PS2 that controls the scan lines GL2_1 to GL2_X.

Further, an example of a method for driving the driver circuit in FIG. 5 will be described.

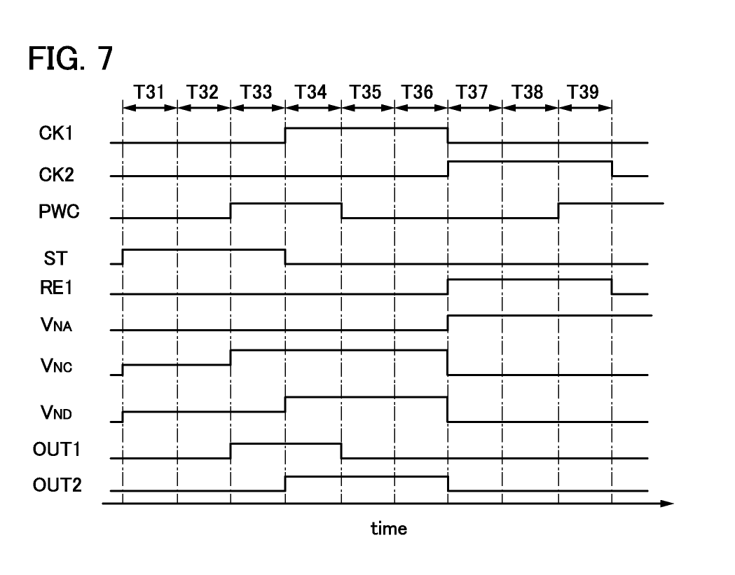

First, an operation example of the flip-flop illustrated in FIG. 6 will be described with reference to a timing chart in FIG. 7. For example, the transistors 301a to 301l in the flip-flop in FIG. 6 are each an n-channel transistor, the transistors 301i and 301k have the same threshold voltage Vth, and the high power supply potential Vdd and the low power supply voltage potential Vss are input as the potential Va and the potential Vb, respectively. Further, the duty ratio of each of the clock signals CK1 and CK2 is 25%, the duty ratio of the pulse width control signal PWC is 33%, and the pulse width of each of the clock signals CK1 and CK2 is 1.5 times as large as that of the pulse width control signal PWC.

To the flip-flop illustrated in FIG. 6, a pulse of the set signal ST is input during periods T31 to T33, so that the flip-flop is brought into a set state.

For example, in the period T31, the transistor 301h is turned on, so that the potential of the node NA becomes equivalent to the potential Vb, and the transistor 301j and the transistor 301l are turned off.

Further, during the period T31, the transistor 301a, the transistor 301c, and the transistor 301d are turned on, and the transistor 301b is turned off, so that the potential of the node NB is increased to the value equivalent to the potential Va, and then, the transistor 301a is turned off.

During the period T33 and a period T34, a pulse of the pulse width control signal PWC is input. In the period T33, with capacitive coupling due to parasitic capacitance generated between the gate of the transistor 301i and the other of the source and the drain thereof, the potential of the node NC is increased to a value which is higher than the sum of the potential Va and the threshold voltage Vth, i.e., Va+Vth+Vx (Vx is a given positive value), so that the transistor 301i is turned on. The flip-flop in FIG. 6, accordingly, outputs a pulse of the pulse signal OUT1 during the periods T33 and T34.

During the period T34 to a period T36, the clock signal CK1 is set to high level. In the period T34, with capacitive coupling due to parasitic capacitance generated between the gate of the transistor 301k and the other of the source and the drain thereof, the potential of the node ND is increased to a value which is higher than the sum of the potential Va and the threshold voltage Vth, i.e., Va+Vth+Vx, so that the transistor 301k is turned on. The flip-flop in FIG. 6, accordingly, outputs a pulse of the pulse signal OUT2 during the periods T34 to T36.

After that, the flip-flop illustrated in FIG. 6 is brought into a reset state by input of a pulse of the reset signal RE1 during periods T37 to T39. In the period T37, for example, the transistor 301g is turned on, whereby the potential of the node NA becomes a value equivalent to the potential Va, and then the transistor 301j and the transistor 301l are turned on. During the periods T37 to T39, the clock signal CK2 is set to high level. In the period T37, the transistor 301f is turned on, whereby each of the potentials of the node NC and the node ND becomes a value equivalent to the potential Vb, and then the transistor 301i and the transistor 301j are turned off. Thus, during the periods T37 to T39, the pulse signal OUT1 and the pulse signal OUT2 are set to low level. The above is the operation example of the flip-flop illustrated in FIG. 6.

As described with reference to FIG. 7, the flip-flop illustrated in FIG. 6 is brought into a set state by input of a pulse of the set signal, and then pulses of the pulse signal OUT1 and the pulse signal OUT2 are output. After that, by input of a pulse of the reset signal, the flip-flop is brought into a reset state, and the pulse signal OUT1 and the pulse signal OUT2 are set to low level.

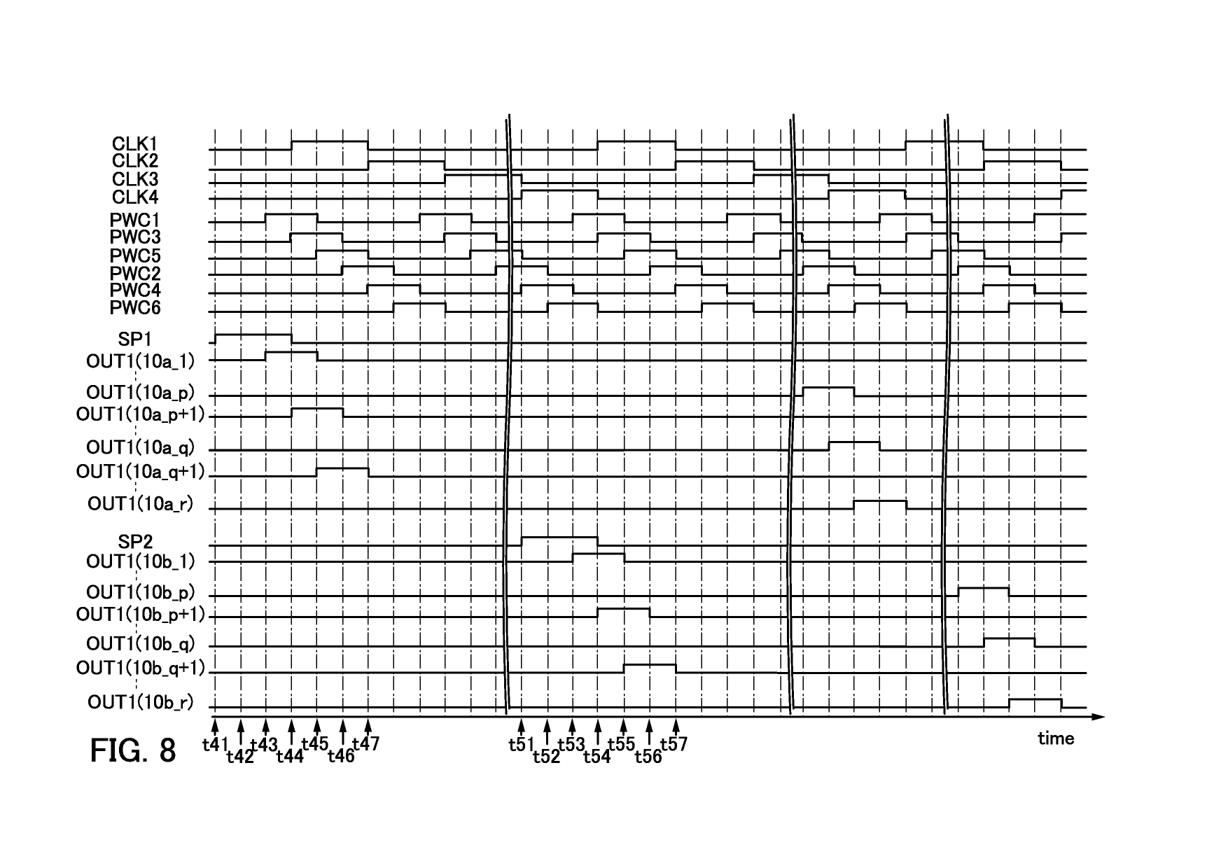

Further, as an example of a method for driving the driver circuit in FIG. 5, an example of a method for driving each of the driver circuits 121 and 122 in the case where the driver circuit in FIG. 5 is used for each of the driver circuits 121 and 122 will be described with reference to a timing chart in FIG. 8. Note that here, the flip-flops 10_1 to 10_{—}r in the driver circuit 121 correspond to flip-flops 10a_1 to 10a_{—}r. Further, the flip-flops 10_1 to 10_{—}r in the driver circuit 122 correspond to flip-flops 10b_1 to 10b_{—}r. As the start pulse SP, a start pulse signal SP1 is input to the driver circuit 121; as the start pulse SP, a start pulse SP2 is input to the driver circuit 122. Here, the pulse width of each of the clock signal CLK1 to a clock signal CLK6 is 1.5 times as large as the pulse width of each of the pulse width control signal PWC 1 to the pulse width control signal PWC6, as an example.

In the example of the method for driving the driver circuits 121 and 122, a pulse of the start pulse signal SP1 is input to the flip-flop 10a_1 in the driver circuit 121 during a period from time t41 to time t44, a pulse of the pulse width control signal PWC1 is input to the driver circuit 121 during a period from time t43 to time t45, and a pulse of the clock signal CLK1 is input to the driver circuit 121 during a period from the time t44 to time t47.

At this time, during the period from the time t43 to the time t45, the flip-flop 10a_1 outputs a pulse of the pulse signal OUT1. Note that before the pulse of the start pulse signal SP1 is input, a pulse of the reset pulse signal RP1 may be input to the flip-flops 10a_1 to 10a_{—}r so that the flip-flops 10a_1 to 10a_{—}r are brought into a reset state.

Further, the flip-flop 10a_{—}p+1 outputs the pulse of the pulse signal OUT1 during the period from the time t44 to the time t46, and the flip-flop 10a_{—}q+1 outputs the pulse of the pulse signal OUT1 during a period from the time t45 to the time t47. Then, the flip-flop 10a_2, the flip-flop 10a_{—}p+2, the flip-flop 10a_{—}q+2, the flip-flop 10a_3, the flip-flop 10a_{—}p+3, and the flip-flop 10a_{—}q+3 sequentially output the pulse of the pulse signal OUT1. The output of the pulse of the pulse signal OUT1 continues until the flip-flop 10a_{—}p, the flip-flop 10a_{—}q, and the flip-flop 10a_{—}r sequentially output the pulse of the pulse signal OUT1.

Further, a pulse of the start pulse signal SP2 is input to the flip-flop 10b_1 during a period from time t51 to time t54, the pulse of the pulse width control signal PWC1 is input to the driver circuit 122 during a period from time t53 to time t55, and the pulse of the clock signal CLK1 is input to the driver circuit 122 during a period from the time t54 to time t56.

At this time, during the period from the time t53 to the time t55, the flip-flop 10b_1 outputs the pulse of the pulse signal OUT1. Note that before the pulse of the start pulse signal SP1 is input, the pulse of the reset pulse signal RP1 may be input to the flip-flops 10b_1 to 10b_{—}r so that the flip-flops 10b_1 to 10b_{—}r are brought into a reset state.

Further, the flip-flop 10b_{—}p+1 outputs the pulse of the pulse signal OUT1 during the period from the time t54 to the time t56, and the flip-flop 10b_{—}q+1 outputs the pulse of the pulse signal OUT1 during a period from the time t55 to time t57. Then, the flip-flop 10b_2, the flip-flop 10b_{—}p+2, the flip-flop 10b_{—}q+2, the flip-flop 10b_3, the flip-flop 10b_{—}p+3, and the flip-flop 10b_{—}q+3 sequentially output the pulse of the pulse signal OUT1. The output of the pulse of the pulse signal OUT1 continues until the flip-flop 10b_{—}p, the flip-flop 10b_{—}q, and the flip-flop 10b_{—}r sequentially output the pulse of the pulse signal OUT1.

Since each of the flip-flops outputs the pulse of the pulse signal OUT1, the transistors 211 or the transistors 212 in the plurality of pixel circuits 111 can be sequentially turned on.

The above is the example of the method for driving the driver circuit 121 and the driver circuit 122.

As described with reference to FIG. 5, FIG. 6, FIG. 7, and FIG. 8, the example of the driver circuit in this embodiment includes the plurality of flip-flops, and the pulse signals output from the plurality of flip-flops are controlled by the plurality of pulse width control signals.

With the above structure, the pixel portion is divided into the plurality of regions in the row direction, and the pixel circuits can be selected on a row basis in each of the plurality of regions. Accordingly, stripes generated at boundaries between the regions due to divisions can be prevented, and the quality of a display image can be further improved.

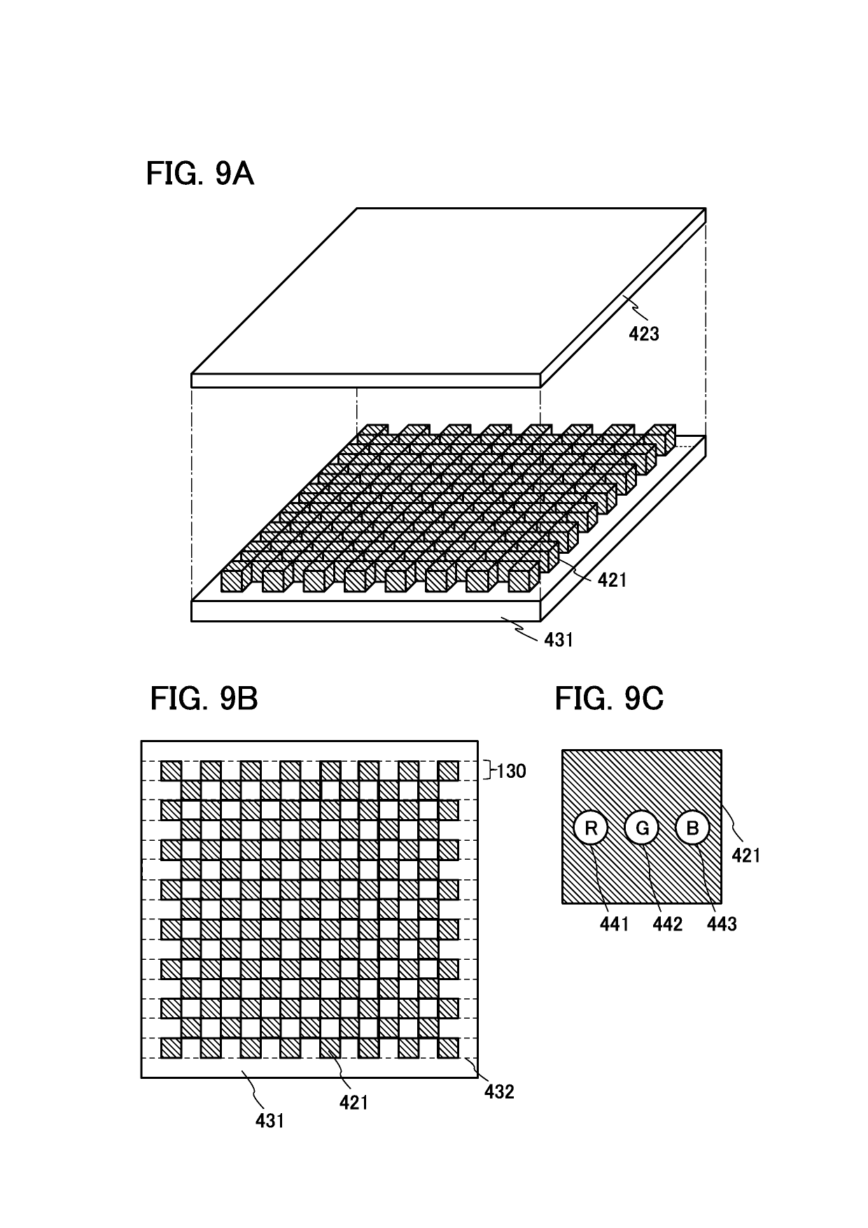

Next, a structural example of the light source portion 103 in FIG. 1A will be described with reference to FIGS. 9A to 9C.

As illustrated in FIG. 9A, the light source portion 103 includes a plurality of LED chips 421 and a diffusion sheet 423.

The plurality of LED chips 421 are arranged in the row and column directions as illustrated in FIG. 9B. The plurality of LED chips 421 are provided on one surface of a substrate 431. Here, the LED chips 421 in each row correspond to the light-emitting region 130.

The LED chip 421 includes, as illustrated in FIG. 9C, a light-emitting diode 441 emitting red light, a light-emitting diode 442 emitting green light, and a light-emitting diode 443 emitting blue light. Light emission from each of the light-emitting diodes 441 to 443 is controlled, whereby light of a color corresponding to data written to the pixel circuit 111 can be emitted.

The diffusion sheet 423 has a function of diffusing light from the light-emitting diodes in the LED chips 421. The diffusion sheet 423 is not necessarily provided; however, with the diffusion sheet 423, generation of unnecessary dark lines in a display image can be prevented.

As the diffusion sheet 423, a sheet diffusing light circularly or elliptically can be used. For example, with the use of a sheet diffusing light elliptically, the number of the LED chips 421, i.e., the number of light-emitting diodes 441 to 443 can be made smaller.

Note that a circuit for controlling light emission from the plurality of LED chips 421 may be provided in the light source portion 103.

The above is a description of the structural example of the light source portion 103.

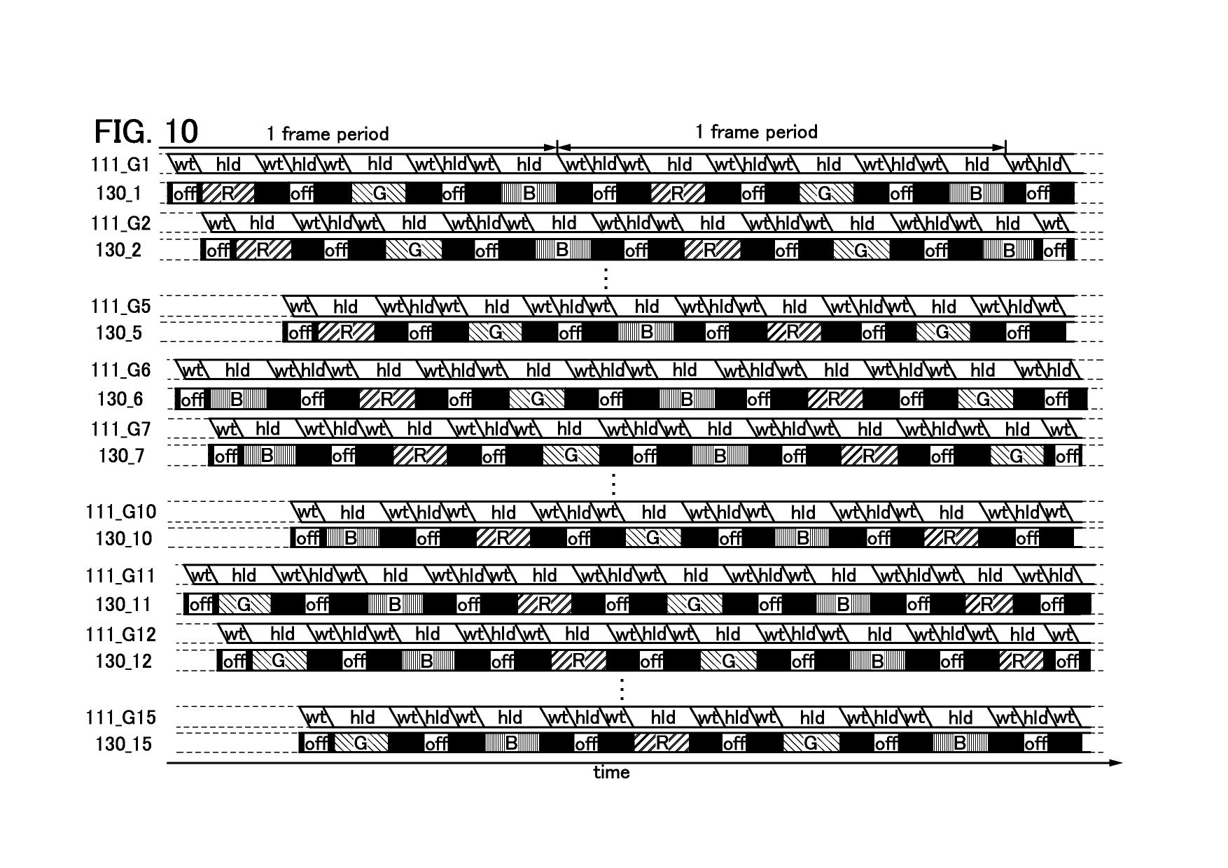

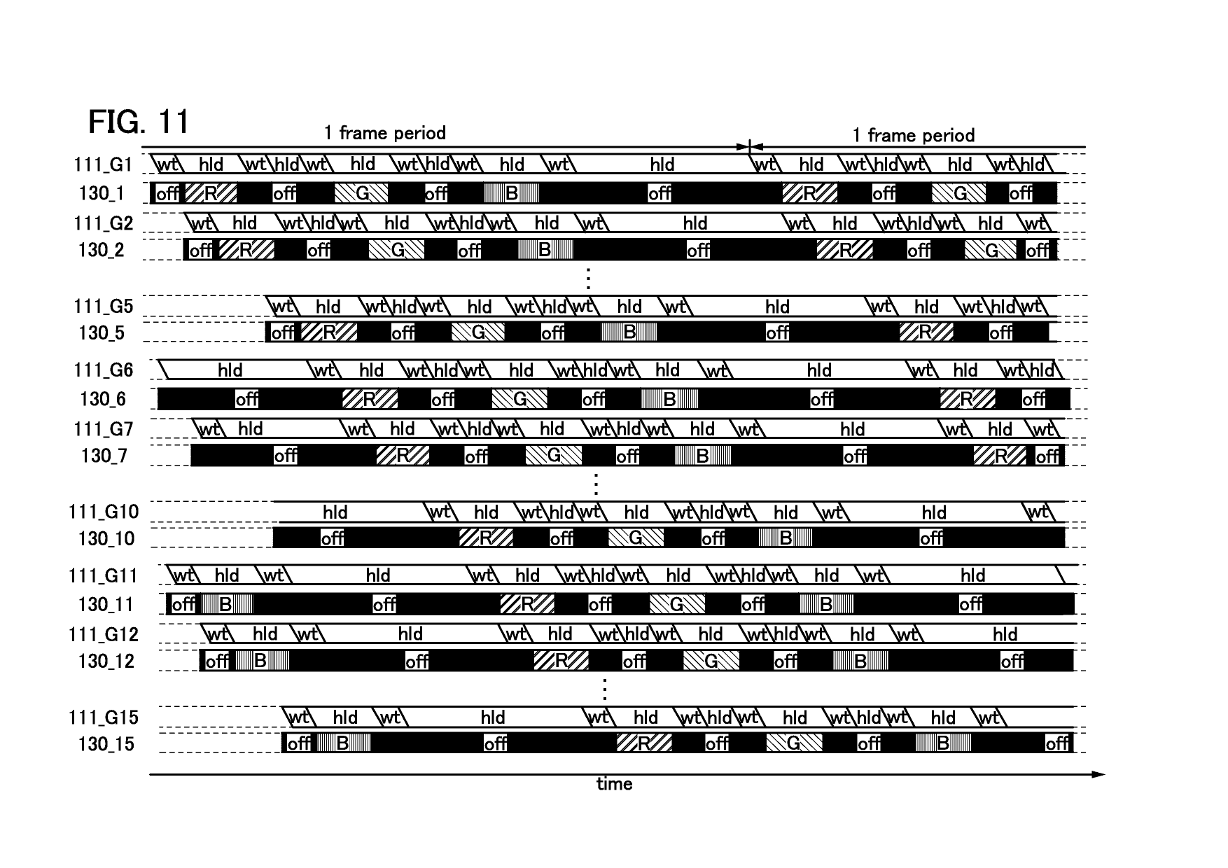

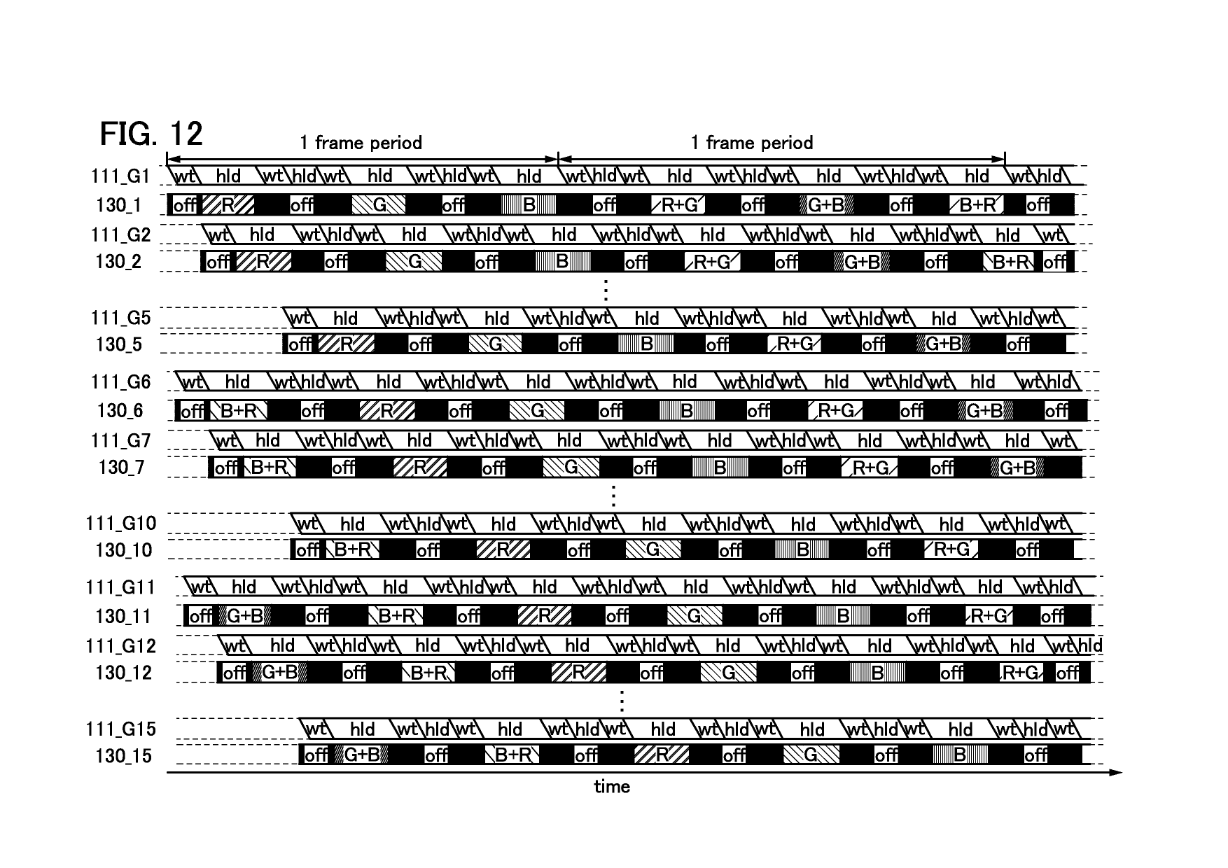

Then, a specific example of a method for driving the display device in this embodiment will be described with reference to timing charts in FIG. 10, FIG. 11, and FIG. 12. Note that the period during which single-color image data is retained is shorter than a period during which a black image is displayed (a period during which the light-emitting region is off) in the timing charts in FIG. 10, FIG. 11, and FIG. 12 for convenience; however, the period during which the single-color image data is retained may be longer than the period during which the black image is displayed.

As illustrated in FIG. 10, in the specific example of the method for driving the display device in this embodiment, the pixel portion 101 is divided into the regions 1 to 3 in the row direction. Further, the pixel circuits 111 in the region 1 are divided into the pixel circuits 111 in a first group (also referred to as pixel circuits 111_G1) to the pixel circuits 111 in a fifth group (also referred to as pixel circuits 111_G5) in the row direction. The pixel circuits 111 in the region 2 are divided into the pixel circuits 111 in a sixth group (also referred to as pixel circuits 111_G6) to the pixel circuits 111 in a tenth group (also referred to as pixel circuits 111_G10) in the row direction. The pixel circuits 111 in the region 3 are divided into the pixel circuits 111 in an eleventh group (also referred to as pixel circuits 111_G11) to the pixel circuits 111 in a fifteenth group (also referred to as pixel circuits 111_G15) in the row direction. Note that there is no particular limitation on the number of the pixel circuits 111 in the row direction in each group.

Note that the light-emitting regions in the light source portion 103 are divided into a first light-emitting region (also referred to as a light-emitting region 130_1) to a fifteenth light-emitting region (also referred to as a light-emitting region 130_15) so as to correspond to the pixel circuits 111 in the respective groups.

Further, data writing (wt) is sequentially performed on the pixel circuits 111 in first groups in the respective regions 1 to 3. Note that the pixel circuits 111 to which data writing is being performed are preferably not irradiated with light by bringing the light-emitting regions 130_1 to 130_15 into an off state as appropriate.

First, as writing operation, black image data is written.

The pixel circuit 111 to which the black image data has been written is brought into a holding state (hld). Note that at this time, the light-emitting region 130 in the light source portion 103 may be turned off. Accordingly, power consumption can be reduced.

Further, as writing operation, single-color image data for displaying the three primary colors is written.

The pixel circuit 111 to which the single-color image data for displaying the three primary colors has been written is brought into the holding state (hld). Note that the period during which the black image data is retained is preferably shorter than the period during which the single-color image data is retained.

Further, in each of the regions 1 to 3, every time the single-color image data for displaying the three primary colors is written to the pixel circuits 111 in each group, the light-emitting regions 130 corresponding to the pixel circuits 111 in each group is made to emit light; in this manner, light corresponding to the data written to the pixel circuits 111 is emitted (display operation).

The above display operation is performed a plurality of times in one frame period.

For example, as illustrated in FIG. 10, in the region 1, single-color image data, i.e., red (R) image data, green (G) image data, and blue (B) image data are sequentially written in one frame period, and the pixel circuits 111_G1 to 111_G5 are sequentially irradiated with red (R) light, green (G) light, and blue (B) light corresponding to the written data from the light-emitting regions 130_1 to 130_5. In the region 2, single-color image data, i.e., blue (B) image data, red (R) image data, and green (G) image data are sequentially written in one frame period, and the pixel circuits 111_G6 to 111_G10 are sequentially irradiated with blue (B) light, red (R) light, and green (G) light corresponding to the written data from the light-emitting regions 130_6 to 130_10. In the region 3, single-color image data, i.e., green (G) image data, blue (B) image data, and red (R) image data are sequentially written in one frame period, and the pixel circuits 111_G11 to 111_G15 are sequentially irradiated with green (G) light, blue (B) light, and red (R) light corresponding to the written data from the light-emitting regions 130_11 to 130_15.

Even in the case where the pixel circuit which is not a target pixel circuit is irradiated with light of a specific color owing to light diffusion, the display image is made black as in the above manner. Accordingly, a display defect can be prevented.

For example, when the pixel circuits 111_G1 are irradiated with red (R) light, the pixel circuits 111_G2 are also irradiated with red (R) light owing to light diffusion in some cases.

At this time, in the case where black image data is not written, a display defect occurs when the pixel circuits in the second group 111_G2 are irradiated with red (R) light because blue image data has been written to the pixel circuits in the second group 111_G2.

However, since black image data is written to the pixel circuits in the second group 111_G2, a black image is displayed even when the pixel circuits in the first group 111_G1 are irradiated with red (R) light. Consequently, a display defect can be prevented.

The method for driving the display device is not limited to that shown in FIG. 10. For example, as shown in FIG. 11, after the pixel circuits 111 in each of the regions 1 to 3 are irradiated with red (R) light, green (G) light, and blue (B) light, they may be brought into the off state in one frame period. In this case, the timing at which black image data is written for the off state is not particularly limited to that shown in FIG. 11 as long as it is before the single-color image data is written.

Further, as shown in FIG. 12, the pixel circuits 111_G1 to 111_G15 in the regions 1 to 3 may be irradiated with red (R) light, green (G) light, and blue (B) light in one frame period, and then may be irradiated with light of red and green (R+G) corresponding to yellow, light of green and blue (G+B) corresponding to cyan, and light of blue and red (B+R) corresponding to magenta in the following frame period.

As described with reference to FIGS. 1A and 1B, FIGS. 2A and 2B, FIGS. 3A and 3B, FIG. 4, FIG. 5, FIG. 6, FIG. 7, FIG. 8, FIGS. 9A to 9C, FIG. 10, FIG. 11, and FIG. 12, in the example of the display device in this embodiment, the pixel portion in which the plurality of pixel circuits are arranged in the row and column direction is divided into the plurality of regions in the row direction, and black image data is written to each of the pixel circuits in the plurality of regions every time before any of single-color image data for displaying the three primary colors is written in one frame period.

Accordingly, even in the case where the pixel circuit which is not a target pixel circuit is irradiated with light of a specific color owing to light diffusion, a display defect can be prevented.

Further, in the example of the display device in this embodiment, the first and second transistors are provided in each of the pixel circuits. The first transistor controls writing of single-color image data for displaying the three primary colors. The second transistor controls writing of black image data. Consequently, the interval between the timing at which single-color image data for displaying the three primary colors is written and the timing at which black image data is written can be made short; thus, writing operation can be performed at high speed.

With the above structure, while the pixel circuits in one group are irradiated with light, data can be written to the pixel circuits in another group; thus, the minimum time required for the operation can be shortened. Consequently, the number of times of data writing can be easily increased, and color breakup can be reduced.

According to the above, the image quality of a display image can be improved.

### Embodiment 2

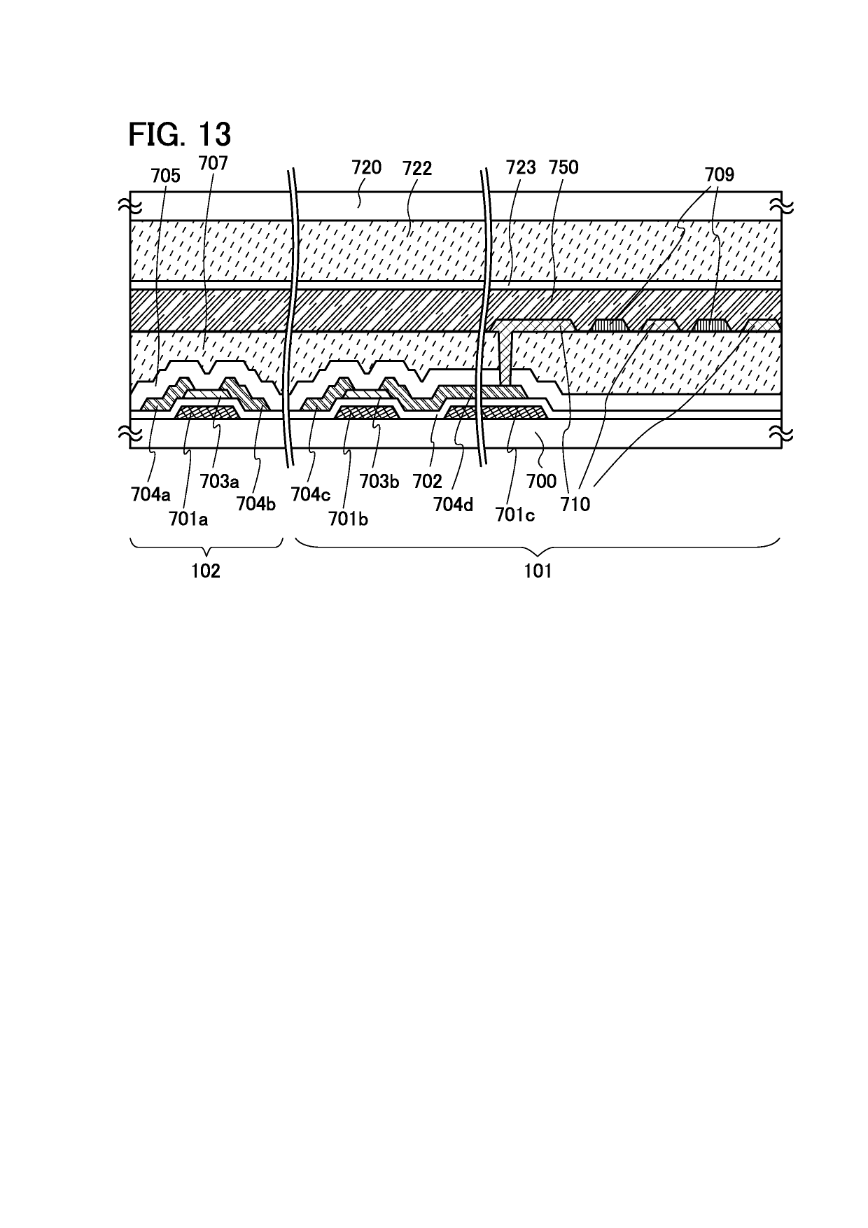

In this embodiment, a structural example of a display device will be described with reference to FIG. 13.

An example of the display device of this embodiment is a liquid crystal display device of a horizontal electric field mode, and includes conductive layers 701a to 701c, an insulating layer 702, semiconductor layers 703a and 703b, conductive layers 704a to 704d, an insulating layer 705, an insulating layer 707, a conductive layer 709, a conductive layer 710, an insulating layer 722, an insulating layer 723, and a liquid crystal layer 750, as illustrated in FIG. 13.

The conductive layers 701a to 701c are provided on one surface of a substrate 700.

The conductive layer 701a is provided in the driver circuit portion 102 illustrated in FIG. 1A. The conductive layer 701a serves as a gate of a transistor in a driver circuit.

The conductive layer 701b is provided in the pixel portion 101 illustrated in FIG. 1A. The conductive layer 701b serves as a gate of a transistor in a pixel circuit.

The conductive layer 701c is provided in the pixel portion 101. The conductive layer 701c serves one of a pair of electrodes of a capacitor in the pixel circuit.

The insulating layer 702 is provided over the conductive layers 701a to 701c. The insulating layer 702 serves as a gate insulating layer of the transistor in the driver circuit, a gate insulating layer of the transistor in the pixel circuit, and a dielectric layer of the capacitor in the pixel circuit.

The semiconductor layer 703a overlaps with the conductive layer 701a with the insulating layer 702 therebetween. The semiconductor layer 703a serves as a layer where a channel is formed (also referred to as a channel formation layer) of the transistor in the driver circuit.

The semiconductor layer 703b overlaps with the conductive layer 701b with the insulating layer 702 therebetween. The semiconductor layer 703b serves as a channel formation layer of the transistor in the pixel circuit.

The conductive layer 704a is electrically connected to the semiconductor layer 703a. The conductive layer 704a serves as one of a source and a drain of the transistor in the driver circuit.

The conductive layer 704b is electrically connected to the semiconductor layer 703a. The conductive layer 704b serves as the other of the source and the drain of the transistor in the driver circuit.

The conductive layer 704c is electrically connected to the semiconductor layer 703b. The conductive layer 704c serves as one of a source and a drain of the transistor in the pixel circuit.

The conductive layer 704d is electrically connected to the semiconductor layer 703b. The conductive layer 704d overlaps with the conductive layer 701c with the insulating layer 702 therebetween. The conductive layer 704d serves as the other of the source and the drain of the transistor in the pixel circuit and the other of the pair of electrodes of the capacitor in the pixel circuit.

The insulating layer 705 is provided over the semiconductor layers 703a and 703b and the conductive layers 704a to 704d. The insulating layer 705 serves as an insulating layer for protecting the transistors (also referred to as a protective insulating layer).

The insulating layer 707 is provided over the insulating layer 705. The insulating layer 707 serves as a planarization layer.

The conductive layer 709 is provided over the insulating layer 707. The conductive layer 709 has a comb-shaped portion. The conductive layer 709 serves as one of a pair of electrodes of a liquid crystal element in the pixel circuit.

The conductive layer 710 is provided over the insulating layer 707 and is electrically connected to the conductive layer 704d through an opening penetrating the insulating layer 705. The conductive layer 710 has a comb-shaped portion. A tooth of the comb-shaped portion of the conductive layer 710 and a tooth of the comb-shaped portion of the conductive layer 709 are alternately provided in parallel. The conductive layer 710 serves as the other of the pair of electrodes of the liquid crystal element in the pixel circuit.

The insulating layer 722 is provided on one surface of a substrate 720. The insulating layer 722 serves as a planarization layer.

The insulating layer 723 is provided on one surface of the insulating layer 722. The insulating layer 723 serves as a protective insulating layer.

The liquid crystal layer 750 is provided over the conductive layers 709 and 710.

Note that the transistors in FIG. 13 are channel-etched transistors, but are not limited thereto; for example, the transistors may be channel-stop transistors or top-gate transistors.

Next, the components of the display device in FIG. 13 will be described. Note that any of the layers may have a layered structure.

A glass substrate or a plastic substrate, for example, can be used for the substrates 700 and 720.

The conductive layers 701a to 701c can be formed using a layer containing a metal material such as molybdenum, titanium, chromium, tantalum, magnesium, silver, tungsten, aluminum, copper, neodymium, or scandium, for example.

The insulating layer 702 can be formed using a layer containing a material such as silicon oxide, silicon nitride, silicon oxynitride, silicon nitride oxide, aluminum oxide, aluminum nitride, aluminum oxynitride, aluminum nitride oxide, or hafnium oxide, for example.

The semiconductor layers 703a and 703b can be formed using a semiconductor layer containing silicon or an oxide semiconductor layer, for example.

The oxide semiconductor layer is in a single crystal state, a polycrystalline (also referred to as polycrystal) state, an amorphous state, or the like. The oxide semiconductor layer may be in a non-single-crystal state. The non-single-crystal state is, for example, structured by at least one of c-axis aligned crystal (CAAC), polycrystal, microcrystal, and an amorphous part. The density of defect states of an amorphous part is higher than those of microcrystal and CAAC. The density of defect states of microcrystal is higher than that of CAAC. Alternatively, the oxide semiconductor layer may be a stack of an amorphous layer and a layer including crystals. The oxide semiconductor layer may include CAAC. The oxide semiconductor layer may include microcrystal.

Examples of an oxide semiconductor that can be used for the oxide semiconductor layer are a metal oxide containing zinc and at least one of indium and gallium, and the metal oxide in which gallium is partly or entirely replaced with another metal element.

As the metal oxide, an In-based metal oxide, a Zn-based metal oxide, an In—Zn-based metal oxide, or an In—Ga—Zn-based metal oxide can be used, for example. Alternatively, the In—Ga—Zn-based metal oxide in which Ga (gallium) is partly or entirely replaced with another metal element may be used.

As the aforementioned another metal element, a metal element that is capable of combining with more oxygen atoms than gallium can be used, for example, and specifically one or more elements of titanium, zirconium, hafnium, germanium, and tin can be used, for instance. Alternatively, as the aforementioned another metal element, one or more elements of lanthanum, cerium, praseodymium, neodymium, samarium, europium, gadolinium, terbium, dysprosium, holmium, erbium, thulium, ytterbium, and lutetium may be used. These metal elements function as a stabilizer. Note that the amount of such a metal element added is determined so that the metal oxide can function as a semiconductor. When a metal element that is capable of combining with more oxygen atoms than gallium is used and oxygen is supplied to a metal oxide, oxygen defects in the metal oxide can be reduced.

For example, when tin is used instead of all of Ga (gallium) contained in the In—Ga—Zn-based metal oxide, an In—Sn—Zn-based metal oxide is obtained. When titanium replaces part of Ga (gallium) contained in the In—Ga—Zn-based metal oxide, an In—Ti—Ga—Zn-based metal oxide is obtained.

The oxide semiconductor layer may be an oxide semiconductor layer including a c-axis aligned crystalline oxide semiconductor (CAAC-OS).

In the CAAC-OS, for example, c-axes are aligned, and a-axes and/or b-axes are not macroscopically aligned.

For example, an oxide semiconductor layer may include microcrystal. Note that an oxide semiconductor including microcrystal is referred to as a microcrystalline oxide semiconductor. A microcrystalline oxide semiconductor layer includes microcrystal (also referred to as nanocrystal) with a size greater than or equal to 1 nm and less than 10 nm, for example. Alternatively, a microcrystalline oxide semiconductor layer, for example, includes a crystal-amorphous mixed phase structure where crystal parts (each of which is greater than or equal to 1 nm and less than 10 nm) are distributed.

For example, an oxide semiconductor layer may include an amorphous part. Note that an oxide semiconductor including an amorphous part is referred to as an amorphous oxide semiconductor. An amorphous oxide semiconductor layer, for example, has disordered atomic arrangement and no crystalline component. Alternatively, an amorphous oxide semiconductor layer is, for example, absolutely amorphous and has no crystal part.

Note that an oxide semiconductor layer may be a mixed film including any of a CAAC-OS, a microcrystalline oxide semiconductor, and an amorphous oxide semiconductor. The mixed film, for example, includes a region of an amorphous oxide semiconductor, a region of a microcrystalline oxide semiconductor, and a region of a CAAC-OS. Further, the mixed film may have a stacked structure including a region of an amorphous oxide semiconductor, a region of a microcrystalline oxide semiconductor, and a region of a CAAC-OS, for example.

Note that an oxide semiconductor layer may be in a single-crystal state, for example.

An oxide semiconductor layer preferably includes a plurality of crystal parts. In each of the crystal parts, a c-axis is preferably aligned in a direction parallel to a normal vector of a surface where the oxide semiconductor layer is formed or a normal vector of a surface of the oxide semiconductor layer. Note that, among crystal parts, the directions of the a-axis and the b-axis of one crystal part may be different from those of another crystal part. An example of such an oxide semiconductor layer is a CAAC-OS film.

The CAAC-OS film is not absolutely amorphous. The CAAC-OS film, for example, includes an oxide semiconductor with a crystal-amorphous mixed phase structure where crystal parts and amorphous parts are intermingled. Note that in most cases, the crystal part fits inside a cube whose one side is less than 100 nm. In an image obtained with a transmission electron microscope (TEM), a boundary between an amorphous part and a crystal part and a boundary between crystal parts in the CAAC-OS film are not clearly detected. Further, with the TEM, a grain boundary in the CAAC-OS film is not clearly found. Thus, in the CAAC-OS film, a reduction in electron mobility due to the grain boundary is suppressed.

In each of the crystal parts included in the CAAC-OS film, for example, a c-axis is aligned in a direction parallel to a normal vector of a surface where the CAAC-OS film is formed or a normal vector of a surface of the CAAC-OS film. Further, in each of the crystal parts, metal atoms are arranged in a triangular or hexagonal configuration when seen from the direction perpendicular to the a-b plane, and metal atoms are arranged in a layered manner or metal atoms and oxygen atoms are arranged in a layered manner when seen from the direction perpendicular to the c-axis. Note that, among crystal parts, the directions of the a-axis and the b-axis of one crystal part may be different from those of another crystal part. In this specification, a term “perpendicular” includes a range from 80° to 100°, preferably from 85° to 95°. In addition, a term “parallel” includes a range from −10° to 10°, preferably from −5° to 5°.

In the CAAC-OS film, distribution of crystal parts is not necessarily uniform. For example, in the formation process of the CAAC-OS film, in the case where crystal growth occurs from a surface side of the oxide semiconductor layer, the proportion of crystal parts in the vicinity of the surface of the oxide semiconductor layer is higher than that in the vicinity of the surface where the oxide semiconductor layer is formed in some cases. Further, when an impurity is added to the CAAC-OS film, the crystal part in a region to which the impurity is added becomes amorphous in some cases.

Since the c-axes of the crystal parts included in the CAAC-OS film are aligned in the direction parallel to a normal vector of a surface where the CAAC-OS film is formed or a normal vector of a surface of the CAAC-OS film, the directions of the c-axes may be different from each other depending on the shape of the CAAC-OS film (the cross-sectional shape of the surface where the CAAC-OS film is formed or the cross-sectional shape of the surface of the CAAC-OS film). Note that the c-axes of the crystal parts are aligned in the direction parallel to a normal vector of the surface where the CAAC-OS film is formed or a normal vector of the surface of the CAAC-OS film. The film deposition is accompanied with the formation of the crystal parts or followed by the formation of the crystal parts through crystallization treatment such as heat treatment.

Change in electric characteristics of a field-effect transistor using the CAAC-OS film as a channel formation layer due to irradiation with visible light or ultraviolet light is small; therefore, the reliability of the field-effect transistor is high.

In the case where an oxide semiconductor layer is used as the semiconductor layers 703a and 703b, the oxide semiconductor layer can be highly purified in the following manner, for example: dehydration or dehydrogenation is performed so that impurities such as hydrogen, water, a hydroxyl group, and a hydride (also referred to as hydrogen compound) are removed from the oxide semiconductor layer, and oxygen is supplied to the oxide semiconductor layer. For example, a layer containing oxygen is used as the layer in contact with the oxide semiconductor layer, and heat treatment is performed; thus, the oxide semiconductor layer can be highly purified.

The oxide semiconductor layer is preferably in a supersaturated state in which the oxygen content is in excess of that in the stoichiometric composition just after its formation. For example, in the case where the oxide semiconductor layer is formed by a sputtering method, the deposition is preferably performed under a condition that the proportion of oxygen in a deposition gas is large, in particular, under an oxygen atmosphere (e.g., oxygen gas: 100%).

The oxide semiconductor layer may be formed by a sputtering method at a substrate temperature higher than or equal to 100° C. and lower than or equal to 500° C., preferably higher than or equal to 200° C. and lower than or equal to 350° C.

Further, in order to sufficiently supply oxygen to supersaturate the oxide semiconductor layer with oxygen, an insulating layer containing excess oxygen may be provided as the insulating layer in contact with the oxide semiconductor layer (e.g., the insulating layers 702 and 705).

The insulating layer containing excess oxygen can be formed using an insulating film which is formed by a sputtering method so as to contain a large amount of oxygen. In order to make the insulating layer contain much more excess oxygen, oxygen is added by an ion implantation method, an ion doping method, or plasma treatment. Moreover, oxygen may be added to the oxide semiconductor layer.

In a sputtering apparatus, an entrapment vacuum pump is preferably used because the amount of moisture remaining in a deposition chamber is preferably small. Further, a cold trap may be used.

In the manufacturing process of the transistor, heat treatment is preferably performed. The temperature of the heat treatment is preferably higher than or equal to 350° C. and lower than the strain point of the substrate, more preferably higher than or equal to 350° C. and lower than or equal to 450° C. Note that the heat treatment may be performed more than once.

As a heat treatment apparatus used for the heat treatment, a rapid thermal annealing (RTA) apparatus such as a gas rapid thermal annealing (GRTA) apparatus or a lamp rapid thermal annealing (LRTA) apparatus may be used. Alternatively, another heat treatment apparatus such as an electric furnace may be used.

After the heat treatment, a high-purity oxygen gas, a high-purity N₂O gas, or ultra-dry air (having a dew point of −40° C. or lower, preferably −60° C. or lower) is preferably introduced in the furnace where the heat treatment has been performed while the heating temperature is being maintained or being decreased. In that case, it is preferable that water, hydrogen, and the like be not contained in the oxygen gas or the N₂O gas. The purity of the oxygen gas or the N₂O gas which is introduced into the heat treatment apparatus is preferably 6N or higher, more preferably 7N or higher. That is, the impurity concentration in the oxygen gas or the N₂O gas is preferably 1 ppm or lower, more preferably 0.1 ppm or lower. Through this step, oxygen is supplied to the oxide semiconductor layer, and defects due to oxygen vacancies in the oxide semiconductor layer can be reduced. Note that the high-purity oxygen gas, high-purity N₂O gas, or ultra-dry air may be introduced at the time of the above heat treatment.

The hydrogen concentration in the highly purified oxide semiconductor layer which is measured by secondary ion mass spectrometry (also referred to as SIMS) is preferably 5×10¹⁹ atoms/cm³ or lower, more preferably 5×10¹⁸ atoms/cm³ or lower, still more preferably 5×10¹⁷ atoms/cm³ or lower.

With the use of the highly purified oxide semiconductor layer, the carrier density of the oxide semiconductor layer in a field-effect transistor can be lower than 1×10¹⁴/cm³, preferably lower than 1×10¹²/cm³, further preferably lower than 1×10¹¹/cm³. Such a low carrier density can reduce the off-state current of the field-effect transistor per micrometer of channel width to 1×10⁻¹⁹ A (100 zA) or less, preferably 1×10⁻²² A (100 yA) or less. It is preferable that the off-state current of the field-effect transistor be as low as possible; the lower limit of the off-state current of the field-effect transistor is estimated to be approximately 1×10⁻³⁰ A/μm.

For example, a layer containing a metal material such as molybdenum, titanium, chromium, tantalum, magnesium, silver, tungsten, aluminum, copper, neodymium, scandium, or ruthenium can be used for the conductive layers 704a to 704d. Alternatively, for example, a layered structure of a layer containing tungsten, a layer containing tantalum nitride, a layer containing copper, and a layer containing titanium may be used for the conductive layers 704a to 704d.

As the insulating layer 705, for example, an oxide insulating layer containing silicon oxide, aluminum oxide, hafnium oxide, or the like can be used.

As each of the insulating layers 707 and 722, for example, a layer of an organic insulating material or an inorganic insulating material can be used.

As the conductive layer 709, for example, a layer of metal oxide which transmits light can be used. For example, metal oxide containing indium or the like can be used.

As the conductive layer 710, for example, a layer of metal oxide which transmits light can be used. For example, metal oxide containing indium or the like can be used.

As the insulating layer 723, for example, a layer containing a material such as silicon oxide, silicon nitride, silicon oxynitride, silicon nitride oxide, aluminum oxide, aluminum nitride, aluminum oxynitride, aluminum nitride oxide, or hafnium oxide can be used.

As the liquid crystal layer 750, for example, a layer including liquid crystal exhibiting a blue phase can be used.

The layer including liquid crystal exhibiting a blue phase contains a liquid crystal composition including liquid crystal exhibiting a blue phase, a chiral agent, a liquid-crystalline monomer, a non-liquid-crystalline monomer, and a polymerization initiator. The liquid crystal exhibiting a blue phase has a short response time and is optically isotropic, which makes the alignment process unneeded and the viewing angle dependence small. Therefore, with the liquid crystal exhibiting a blue phase, the operation speed of the liquid crystal display device can be increased.

The above is the description of the structural example of the display device illustrated in FIG. 13.

In an example of the display device of this embodiment, a driver circuit is provided over the same substrate as a pixel circuit, as described with reference to FIG. 13. Thus, the number of wirings for connecting the pixel circuit and the driver circuit can be reduced.

### Embodiment 3

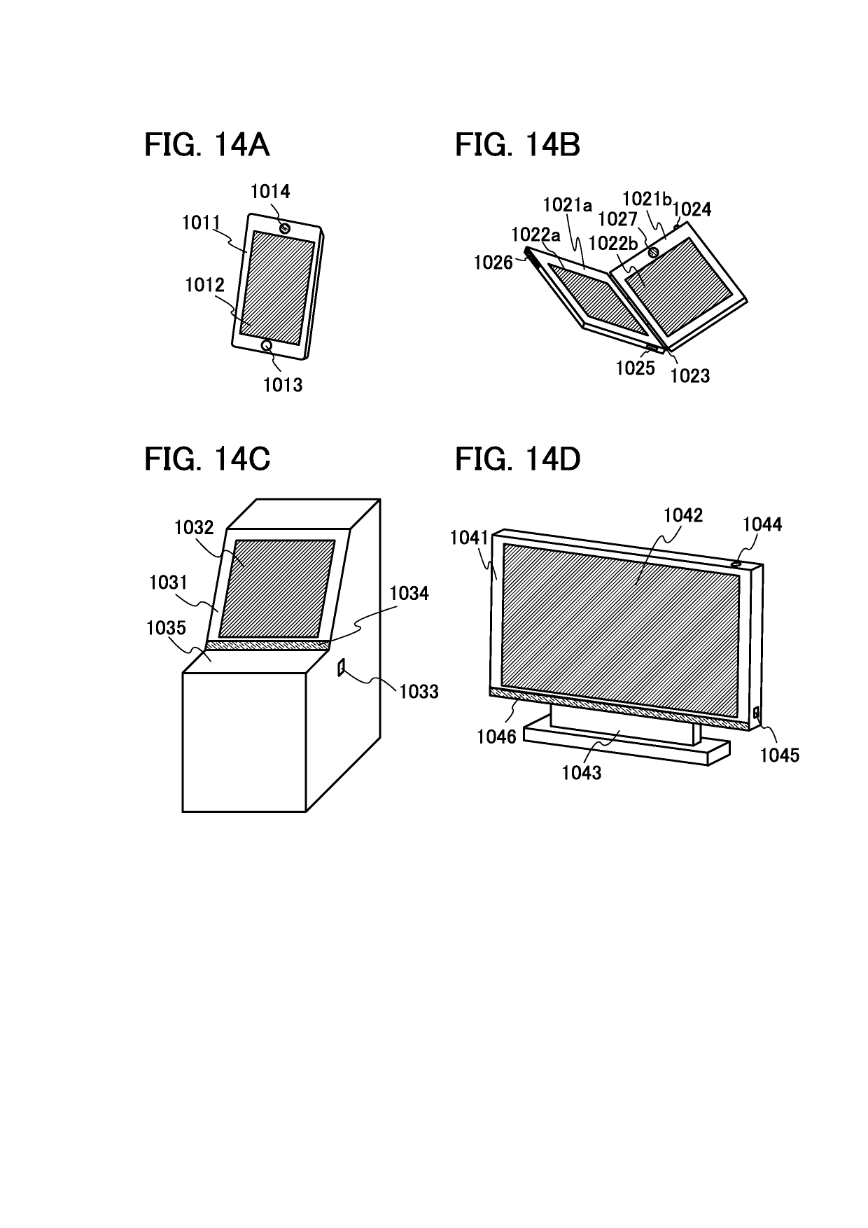

In this embodiment, examples of an electronic device including a panel which uses a display device according to one embodiment of the present invention will be described with reference to FIGS. 14A to 14D.

The electronic device illustrated in FIG. 14A is an example of a portable information terminal.

The electronic device illustrated in FIG. 14A includes a housing 1011, a panel 1012 incorporated in the housing 1011, a button 1013, and a speaker 1014.

The housing 1011 may be provided with a connection terminal for connecting the electronic device to an external device and a button for operating the electronic device.

The panel 1012 is a display panel (display) and preferably has a function of a touch panel.

The panel 1012 is formed using a display device according to one embodiment of the present invention.

The button 1013 is provided on the housing 1011. For example, when the button 1013 is a power button, pressing the button 1013 can turn on or off the electronic device.

The speaker 1014 is provided on the housing 1011. The speaker 1014 outputs sound.

The housing 1011 may be provided with a microphone, in which case the electronic device in FIG. 14A can function as a telephone, for example.

The electronic device in FIG. 14A functions as at least one of a telephone, an e-book reader, a personal computer, and a game machine, for example.

The electronic device illustrated in FIG. 14B is an example of a foldable information terminal.

The electronic device illustrated in FIG. 14B includes a housing 1021a, a housing 1021b, a panel 1022a incorporated in the housing 1021a, a panel 1022b incorporated in the housing 1021b, a hinge 1023, a button 1024, a connection terminal 1025, a storage medium insertion portion 1026, and a speaker 1027.

The housing 1021a and the housing 1021b are connected with the hinge 1023.

Each of the panels 1022a and 1022b is a display panel (display) and preferably has a function of a touch panel.

Each of the panels 1022a and 1022b is formed using a display device according to one embodiment of the present invention.

Since the electronic device in FIG. 14B includes the hinge 1023, it can be folded so that the panels 1022a and 1022b face each other.

The button 1024 is provided on the housing 1021b. Note that the button 1024 may be provided on the housing 1021a. For example, when the button 1024 having a function of a power button is provided, supply of power supply voltage to the electronic device can be controlled by pressing the button 1024.

The connection terminal 1025 is provided on the housing 1021a. Note that the connection terminal 1025 may be provided on the housing 1021b. Alternatively, a plurality of connection terminals 1025 may be provided on one of or both the housings 1021a and 1021b. The connection terminal 1025 is a terminal for connecting the electronic device in FIG. 14B to another device.

The storage medium insertion portion 1026 is provided on the housing 1021a. The storage medium insertion portion 1026 may be provided on the housing 1021b. Alternatively, a plurality of storage medium insertion portions 1026 may be provided on one of or both the housings 1021a and 1021b. For example, when a card storage medium is inserted into the storage medium insertion portion, data can be read from the card storage medium and sent to the electronic device, or data stored in the electronic device can be written to the card storage medium.

The speaker 1027 is provided on the housing 1021b. The speaker 1027 outputs sound. Note that the speaker 1027 may be provided on the housing 1021a.

The housing 1021a or the housing 1021b may be provided with a microphone, in which case the electronic device in FIG. 14B can function as a telephone, for example.

The electronic device in FIG. 14B functions as at least one of a telephone, an e-book reader, a personal computer, and a game machine, for example.

The electronic device illustrated in FIG. 14C is an example of a stationary information terminal. The stationary information terminal illustrated in FIG. 14C includes a housing 1031, a panel 1032 incorporated in the housing 1031, a button 1033, and a speaker 1034.

The panel 1032 is a display panel (display) and preferably has a function of a touch panel.

The panel 1032 is formed using a display device according to one embodiment of the present invention.

Note that a panel similar to the panel 1032 may be provided on a top board 1035 of the housing 1031, in which case the panel preferably has a function of a touch panel.

Further, the housing 1031 may be provided with a ticket slot for issuing a ticket or the like, a coin slot, a bill slot, and/or the like.

The button 1033 is provided on the housing 1031. For example, when the button 1033 is a power button, supply of power supply voltage to the electronic device can be controlled by pressing the button 1033.

The speaker 1034 is provided on the housing 1031. The speaker 1034 outputs sound.

The electronic device in FIG. 14C serves as an automated teller machine, an information communication terminal (also referred to as multimedia station) for ordering a ticket or the like, or a game machine, for example.

FIG. 14D illustrates an example of a stationary information terminal. The electronic device in FIG. 14D includes a housing 1041, a panel 1042 incorporated in the housing 1041, a support 1043 for supporting the housing 1041, a button 1044, a connection terminal 1045, and a speaker 1046.

Note that the housing 1041 may be provided with a connection terminal for connecting the electronic device in FIG. 14D to an external device.

The panel 1042 functions as a display panel (display).

The panel 1042 is formed using a display device according to one embodiment of the present invention.

The button 1044 is provided on the housing 1041. For example, when the button 1044 is a power button, supply of power supply voltage to the electronic device can be controlled by pressing the button 1044.

The connection terminal 1045 is provided on the housing 1041. The connection terminal 1045 is a terminal for connecting the electronic device in FIG. 14D to another device. For example, when the electronic device in FIG. 14D and a personal computer are connected with the connection terminal 1045, the panel 1042 can display an image corresponding to a data signal input from the personal computer. For example, when the panel 1042 of the electronic device in FIG. 14D is larger than a panel of another electronic device connected thereto, a displayed image of the other electronic device can be enlarged, so that a plurality of viewers can easily see the image at the same time.

The speaker 1046 is provided on the housing 1041. The speaker 1046 outputs sound.

The electronic device in FIG. 14D functions as at least one of an output monitor, a personal computer, and a television set, for example.

The above is a description of the electronic devices illustrated in FIGS. 14A to 14D.

As described with reference to FIGS. 14A to 14D, the electronic devices in this embodiment can display a high-quality image by using a display device according to one embodiment of the present invention.

This application is based on Japanese Patent Application serial no. 2012-052723 filed with Japan Patent Office on Mar. 9, 2012, the entire contents of which are hereby incorporated by reference.

What is claimed is:

1. A method for driving a display device comprising a pixel portion which comprises a plurality of pixel circuits in row direction and column direction and which is divided into a plurality of regions in the row direction, the method comprising the steps of:
in each of the plurality of regions, performing operation in which data is written to the plurality of pixel circuits on a row basis and the plurality of pixel circuits to which the data is written are irradiated with light corresponding to the data written to the plurality of pixel circuits a plurality of times in one frame period in such a manner that at least three single-color image data for displaying three primary colors are written in one frame period; and
writing black image data to the plurality of pixel circuits every time before any of the three single-color image data is written to the plurality of pixel circuits.

2. The method for driving the display device, according to claim 1,
wherein a period during which the black image data is retained is shorter than a period during which each of the three single-color image data is retained.

3. The method for driving the display device, according to claim 1 further comprising the step of:
retaining each of the three single-color image data for displaying the three primary colors.

4. The method for driving the display device, according to claim 1 further comprising the steps of:
retaining each of the three single-color image data for displaying the three primary colors; and
retaining the black image data.

5. The method for driving the display device, according to claim 1,
wherein the three single-color image data are red image data, green image data and blue image data.

6. The method for driving the display device, according to claim 1,
wherein the three single-color image data are yellow image data, cyan image data and magenta image data.

7. The method for driving the display device, according to claim 1,
wherein the plurality of regions are three regions.

8. A display device comprising:
a pixel portion comprising a plurality of pixel circuits in row direction and column direction; and
a driver circuit portion which controls driving of the plurality of pixel circuits,
wherein each of the plurality of pixel circuits comprises:
a liquid crystal element whose alignment state depends on data written to the liquid crystal element;
a first transistor having a function of controlling whether to write single-color image data for displaying three primary colors as the data by being turned on or off; and
a second transistor having a function of controlling whether to write black image data as the data by being turned on or off, and
wherein the driver circuit portion comprises:
a first driver circuit which controls a potential of a gate of the first transistor in each of the plurality of pixel circuits in each of a plurality of regions into which the pixel portion is divided in the row direction; and
a second driver circuit which controls a potential of a gate of the second transistor in each of the plurality of pixel circuits such that, before the first transistor is turned on, the second transistor is turned on and then turned off.

9. The display device according to claim 8, further comprising a light source portion,
wherein each of the plurality of regions is divided into a plurality of light-emitting regions in the row direction, and
wherein the plurality of pixel circuits in each of the plurality of light-emitting regions are sequentially irradiated with light whose color corresponds to the data, from the light source portion.

10. The display device according to claim 8,
wherein each of the plurality of pixel circuits further comprises a capacitor.

11. The display device according to claim 8,
wherein the driver circuit portion further comprises a third driver circuit having a function of generating signals of the data.

12. The display device according to claim 8,
wherein each of the first driver circuit and the second driver circuit includes flip-flops.

13. The display device according to claim 8,
wherein the first driver circuit and the second driver circuit are provided on both sides of the pixel portion.

14. An electronic device comprising a panel which uses the display device according to claim 8.
